(19) United States
(12) Patent Application Publication
(10) Pub. No.: US 2025/0037704 A1
(43) Pub. Date: Jan. 30, 2025

(54) VOICE RECOGNITION METHOD, APPARATUS, SYSTEM, ELECTRONIC DEVICE, STORAGE MEDIUM, AND COMPUTER PROGRAM PRODUCT

(71) Applicant: Tencent Technology (Shenzhen) Company Limited, Shenzhen (CN)

(72) Inventors: Mingle LIU, Shenzhen (CN); Dong YANG, Shenzhen (CN); Yipeng YU, Shenzhen (CN)

(21) Appl. No.: 18/911,403

(22) Filed: Oct. 10, 2024

Related U.S. Application Data
(63) Continuation of application No. PCT/CN2023/121239, filed on Sep. 25, 2023.

(30) Foreign Application Priority Data
Nov. 4, 2022 (CN) 2022113733043

(51) Int. Cl. G10L 15/02; G10L 15/30

(52) U.S. Cl. CPC G10L 15/02; G10L 15/30

(57) ABSTRACT

A voice recognition method, apparatus, electronic device, storage medium, and computer program product are provided herein The method includes performing a sliding window interception on a voice signal to obtain at least a first sub-voice signal and a second sub-voice signal, performing voice feature extractions on the first sub-voice signal and the second sub-voice signal to obtain a first sub-voice embedded representation feature of the first sub-voice signal and a second sub-voice embedded representation feature of the second sub-voice signal, obtaining an embedded representation feature of each contrastive word in a preset contrastive word library, performing a first voice recognition on the first sub-voice signal to obtain a first sub-voice recognition result, performing a second voice recognition on the second sub-voice signal to obtain a second sub-voice recognition result, and determining a voice recognition result based on the first and second sub-voice recognition results.

### RELATED APPLICATION

This application is a continuation application of PCT Application PCT/CN2023/121239, filed Sep. 25, 2023, which claims priority to Chinese Patent Application No. 202211373304.3 filed on Nov. 4, 2022, each entitled “VOICE RECOGNITION METHOD AND APPARATUS, ELECTRONIC DEVICE, STORAGE MEDIUM, AND COMPUTER PROGRAM PRODUCT”, and each which is incorporated herein by reference in its entirety.

### FIELD

One or more aspects of this application relate to the field of Internet technologies, and relates to, but not limited to, a voice recognition method, apparatus, electronic device, storage medium, and computer program product.

### BACKGROUND

A voice keyword matching technology is intended to recognize a specific word in a voice segment based on a reference voice. The voice keyword matching technology has always been a research hotspot in the field of voice recognition. At present, the voice keyword matching technology mainly includes conventional methods and deep learning methods.

The conventional methods mainly include a dynamic time warping (DTW) method and related methods. In the deep learning methods, an embedded feature extractor is obtained through training by using a supervised method or an unsupervised method. A Mel frequency cepstrum coefficient (MFCC) of audio is extracted based on the embedded feature extractor, and a similarity between MFCC features of target audio and annotated audio is calculated, to determine whether the target audio includes a keyword.

However, the foregoing conventional methods have large calculation requirements, and the calculation accuracy is easily susceptible to an impact of an external environment, leading to the problem of low recognition accuracy. The deep learning methods have problems of a limited expression capability and low recognition accuracy.

### SUMMARY

One or more aspects of this application provide a voice recognition method, apparatus, electronic device, storage medium, and computer program product. The voice recognition method, apparatus, electronic device, storage medium, and/or computer program product may be used in the fields of artificial intelligence and games. For example, voice recognition method, apparatus, electronic device, storage medium, and/or computer program product may be used to accurately extract a sub-voice embedded representation feature of a sub-voice signal, and then use the sub-voice embedded representation feature may be used to accurately recognize a to-be-recognized voice signal.

Technical solutions of the one or more aspects of this application may be implemented as follows:

One or more aspects of this application provide a voice recognition method. The method may be performed by the electronic device and may comprise: performing a sliding window interception on a to-be-recognized voice signal to obtain at least a first sub-voice signal and a second sub-voice signal; performing a first voice feature extraction on the first sub-voice signal using a pre-trained embedded feature representation system to obtain a first sub-voice embedded representation feature of the first sub-voice signal, the pre-trained embedded feature representation system comprising a first-stage feature extraction network and a second-stage feature extraction network, wherein the first-stage feature extraction network performs a first-stage voice feature extraction on the first sub-voice signal to obtain a first-stage voice feature, wherein the second-stage feature extraction network performs a second-stage voice feature extraction on the first sub-voice signal based on the first-stage voice feature, and wherein a first feature extraction precision of the first-stage voice feature extraction is less than a second feature extraction precision of the second-stage voice feature extraction; performing a second voice feature extraction on the second sub-voice signal using the pre-trained embedded feature representation system to obtain a second sub-voice embedded representation feature of the second sub-voice signal, wherein the first-stage feature extraction network performs the first-stage voice feature extraction on the second sub-voice signal to obtain a second first-stage voice feature, wherein the second-stage feature extraction network performs the second-stage voice feature extraction on the second sub-voice signal based on the second first-stage voice feature; obtaining an embedded representation feature of each contrastive word in a preset contrastive word library; performing a first voice recognition on the first sub-voice signal based on the first sub-voice embedded representation feature and the embedded representation feature of each contrastive word to obtain a first sub-voice recognition result; performing a second voice recognition on the second sub-voice signal based on the second sub-voice embedded representation feature and the embedded representation feature of each contrastive word to obtain a second sub-voice recognition result; and determining a voice recognition result corresponding to the to-be-recognized voice signal according to the first sub-voice recognition result and the second sub-voice recognition result.

One or more aspects of this application provide a voice recognition apparatus comprising one or more processors and memory storing computer-readable instructions that when executed by the one or more processors causes the apparatus to perform a voice recognition method comprising performing a sliding window interception on a to-be-recognized voice signal to obtain at least a first sub-voice signal and a second sub-voice signal; performing a first voice feature extraction on the first sub-voice signal using a pre-trained embedded feature representation system to obtain a first sub-voice embedded representation feature of the first sub-voice signal, the pre-trained embedded feature representation system comprising a first-stage feature extraction network and a second-stage feature extraction network, wherein the first-stage feature extraction network performs a first-stage voice feature extraction on the first sub-voice signal to obtain a first-stage voice feature, wherein the second-stage feature extraction network performs a second-stage voice feature extraction on the first sub-voice signal based on the first-stage voice feature, and wherein a first feature extraction precision of the first-stage voice feature extraction is less than a second feature extraction precision of the second-stage voice feature extraction; performing a second voice feature extraction on the second sub-voice signal using the pre-trained embedded feature representation system to obtain a second sub-voice embedded representation feature of the second sub-voice signal, wherein the first-stage feature extraction network performs the first-stage voice feature extraction on the second sub-voice signal to obtain a second first-stage voice feature, wherein the second-stage feature extraction network performs the second-stage voice feature extraction on the second sub-voice signal based on the second first-stage voice feature; obtaining an embedded representation feature of each contrastive word in a preset contrastive word library; performing a first voice recognition on the first sub-voice signal based on the first sub-voice embedded representation feature and the embedded representation feature of each contrastive word to obtain a first sub-voice recognition result; performing a second voice recognition on the second sub-voice signal based on the second sub-voice embedded representation feature and the embedded representation feature of each contrastive word to obtain a second sub-voice recognition result; and determining a voice recognition result corresponding to the to-be-recognized voice signal according to the first sub-voice recognition result and the second sub-voice recognition result.

One or more aspects of this application provide a voice recognition device, which may comprise: a memory, having executable instructions stored therein; and a processor, configured to implement, when executing the executable instructions stored in the memory, the voice recognition method described herein.

One or more aspects of this application provide a computer program product or a computer program, the computer program product or the computer program including executable and computer-readable instructions, the executable instructions being stored in a non-transitory computer-readable storage medium which, when reading the executable instructions from the computer-readable storage medium and executing the executable instructions, implement the voice recognition method described herein.

One or more aspects of this application provide a non-transitory computer-readable storage medium, having executable instructions stored therein, configured to cause a processor, when executing the executable instructions, to implement the voice recognition method described herein and comprising performing a sliding window interception on a to-be-recognized voice signal to obtain at least a first sub-voice signal and a second sub-voice signal; performing a first voice feature extraction on the first sub-voice signal using a pre-trained embedded feature representation system to obtain a first sub-voice embedded representation feature of the first sub-voice signal, the pre-trained embedded feature representation system comprising a first-stage feature extraction network and a second-stage feature extraction network, wherein the first-stage feature extraction network performs a first-stage voice feature extraction on the first sub-voice signal to obtain a first-stage voice feature, wherein the second-stage feature extraction network performs a second-stage voice feature extraction on the first sub-voice signal based on the first-stage voice feature, and wherein a first feature extraction precision of the first-stage voice feature extraction is less than a second feature extraction precision of the second-stage voice feature extraction; performing a second voice feature extraction on the second sub-voice signal using the pre-trained embedded feature representation system to obtain a second sub-voice embedded representation feature of the second sub-voice signal, wherein the first-stage feature extraction network performs the first-stage voice feature extraction on the second sub-voice signal to obtain a second first-stage voice feature, wherein the second-stage feature extraction network performs the second-stage voice feature extraction on the second sub-voice signal based on the second first-stage voice feature; obtaining an embedded representation feature of each contrastive word in a preset contrastive word library; performing a first voice recognition on the first sub-voice signal based on the first sub-voice embedded representation feature and the embedded representation feature of each contrastive word to obtain a first sub-voice recognition result; performing a second voice recognition on the second sub-voice signal based on the second sub-voice embedded representation feature and the embedded representation feature of each contrastive word to obtain a second sub-voice recognition result; and determining a voice recognition result corresponding to the to-be-recognized voice signal according to the first sub-voice recognition result and the second sub-voice recognition result.

The one or more aspects of this application have at least the following non-limiting beneficial effects: the embedded feature representation system formed by the first-stage feature extraction network and the second-stage feature extraction network performs a voice feature extraction on each sub-voice signal obtained by performing a sliding window interception to obtain a sub-voice embedded representation feature; performs a voice recognition on each sub-voice signal according to the sub-voice embedded representation feature and an embedded representation feature of each contrastive word in a preset contrastive word library to obtain a sub-voice recognition result; and determines a voice recognition result corresponding to a to-be-recognized voice signal according to sub-voice recognition results of at least two sub-voice signals. In this way, because a feature extraction precision of performing a second-stage voice feature extraction by the second-stage feature extraction network in the embedded feature representation system is greater than a feature extraction precision of performing a first-stage voice feature extraction by the first-stage feature extraction network. Therefore, the embedded feature representation system can accurately extract the sub-voice embedded representation feature of each sub-voice signal, so that an accurate voice recognition can be performed on the to-be-recognized voice signal based on the sub-voice embedded representation feature.

### BRIEF DESCRIPTION OF THE DRAWINGS

FIG. 1 is a schematic flowchart of one or more aspects of an example of a voice keyword matching method in the related art.

FIG. 2 is a schematic flowchart of one or more aspects of an example of voice keyword matching method in the related art.

FIG. 3 is a schematic architectural diagram of one or more aspects of an example of a voice recognition system.

FIG. 4 is a schematic structural diagram of one or more aspects of an example of an electronic device.

FIG. 5 is a schematic flowchart of one or more aspects of an example of a voice recognition method.

FIG. 6 is optional schematic flowchart of one or more aspects of an example of a voice recognition method.

FIG. 7 is a schematic flowchart of one or more aspects of an example of a method for training an embedded feature representation system.

FIG. 8 is a schematic flowchart of one or more aspects of an example of a method for training a first-stage feature extraction network.

FIG. 9 is a schematic flowchart of one or more aspects of an example of a method for training a second-stage feature extraction network.

FIG. 10 is a schematic diagram of one or more aspects of an example of a voice keyword matching system.

FIG. 11 is a schematic flowchart of one or more aspects of an example of training a wav2vec model.

FIG. 12 is a schematic flowchart of one or more aspects of an example of training an ecapa-tdnn model.

FIG. 13 is a schematic structural diagram of one or more aspects of an example of a wav2vec model.

FIG. 14 is a schematic structural diagram of one or more aspects of an example of an ecapa-tdnn model.

FIG. 15 is a schematic structural diagram of one or more aspects of an example of an SE-ResBlock part in an ecapa-tdnn model.

### DETAILED DESCRIPTION

To make the objectives, technical solutions, and advantages of this application clearer, the following further describes this application in detail with reference to the accompanying drawings. The described aspects are not to be considered as a limitation to this application. All other aspects obtained by a person of ordinary skill in the art without creative efforts shall fall within the scope of protection of this application.

In the following descriptions, related “some aspects” describe a subset of all possible aspects. However, the “some aspects” may be the same subset or different subsets of all the possible aspects, and may be combined with each other without conflict. Unless otherwise defined, meanings of all technical and scientific terms used in the aspects of this application are the same as those usually understood by a person skilled in the art to which the aspects of this application belong. Terms used in the aspects of this application are merely intended to describe the specific aspects of this application, but are not intended to limit this application.

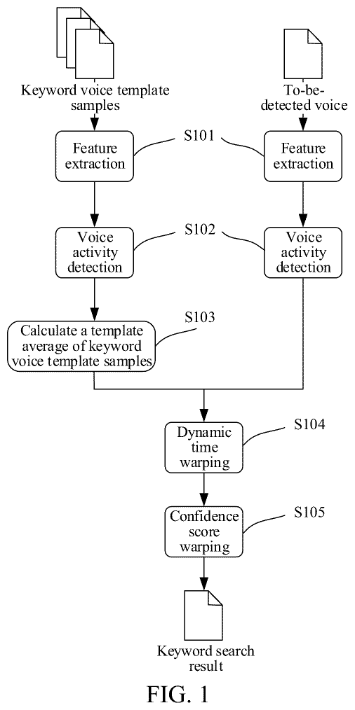

Solutions in the related art mainly include conventional methods and decp learning methods. FIG. 1 is a schematic flowchart of a voice keyword matching method in the related art. As shown in FIG. 1, the conventional methods are mainly based on DTW. First, keyword voice template samples and a to-be-searched voice are preprocessed, including Mel feature extraction in Operation S101 and voice activity detection (VAD) in Operation S102. Subsequently, DTW scores of the template samples and a to-be-detected sample are calculated, to be specific, a template average of the keyword voice template samples is calculated in Operation S103, dynamic time warping in Operation S104 is performed, confidence score warping in Operation S105 is performed, and scores of the to-be-searched voice and all keyword voice template samples are compared, to obtain a final keyword search result according to a threshold.

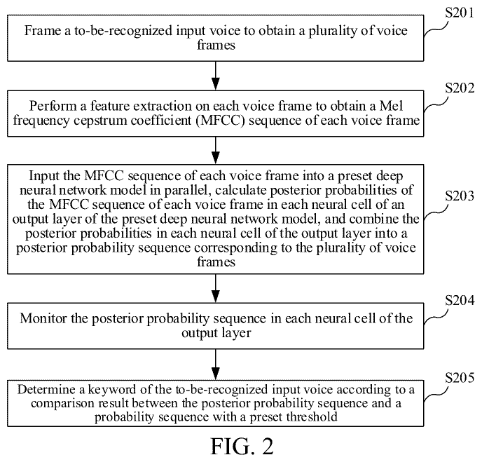

FIG. 2 is a schematic flowchart of another voice keyword matching method in the related art. As shown in FIG. 2, in the field of deep learning, first, in Operation S201, a to-be-recognized input voice is framed to obtain a plurality of voice frames. Then, in Operation S202, a feature extraction is performed on each voice frame to obtain a Mel frequency cepstrum coefficient (MFCC) sequence of each voice frame. In Operation S203, the MFCC sequence of each voice frame is inputted into a preset deep neural network model in parallel, posterior probabilities of the MFCC sequence of each voice frame in each neural cell of an output layer of the preset deep neural network model are calculated, and the posterior probabilities in each neural cell of the output layer are combined into a posterior probability sequence corresponding to the plurality of voice frames, each neural cell of the output layer corresponding to one keyword. Next, in Operation S204, the posterior probability sequence in each neural cell of the output layer is monitored. Finally, in Operation S205, a keyword of the to-be-recognized input voice is determined according to a comparison result between the posterior probability sequence and a probability sequence with a preset threshold. In other words, in the deep learning methods, MFCC features of training audio data are extracted, then a corresponding deep neural network is constructed, and finally a corresponding classification model is trained based on feature data.

However, in processes of extracting an embedded feature by using the conventional methods and deep learning methods in the related art, DTW has deficiencies of a large calculation amount and easy susceptibility to an impact of an external environment. The deep learning technology has deficiencies of a limited expression capability and inadequate recognition accuracy. In addition, the methods in the related art all have the problem of inadequate robustness in dealing with complex game voices. In addition, extraction is performed based on Mel features in all the methods in the related art, and therefore, the accuracy of feature extraction is not high. The methods in the related art all have the problem of low accuracy of a voice recognition.

Based on at least one problem in the methods in the related art, the one or more aspects of this application provide a voice recognition method. The method is a game voice keyword matching method based on a pre-trained model. The method may include two submodules: an unsupervised pre-trained model and a supervised pre-trained model. The function of the unsupervised pre-trained model is to perform a contrastive learning on a large-scale corpus to enable the model to learn distinguishing embedded representation features on a sentence level based on a sufficient data volume. The function of a supervised pre-trained model is reifying a subtask of voice matching, and segmenting a Chinese corpus into single words, to enable a network to further learn embedded representations of the single words based on features of preceding sentences. The embedded expression features extracted as described herein have an excellent recognition rate and generalization capability, so that voice keyword check and recognition tasks can be completed quickly.

In the voice recognition method provided herein, first, a sliding window interception may be performed on a to-be-recognized voice signal to obtain at least two sub-voice signals; then a voice feature extraction may be performed on each sub-voice signal through a pre-trained embedded feature representation system to obtain a sub-voice embedded representation feature of the corresponding sub-voice signal, the embedded feature representation system including a first-stage feature extraction network and a second-stage feature extraction network, the first-stage feature extraction network being configured to perform a first-stage voice feature extraction on the sub-voice signal to obtain a first-stage voice feature, the second-stage feature extraction network being configured to perform a second-stage voice feature extraction on the sub-voice signal based on the first-stage voice feature, a feature extraction precision of the second-stage voice feature extraction being greater than a feature extraction precision of the first-stage voice feature extraction; an embedded representation feature of each contrastive word in a preset contrastive word library may be acquired; next, a voice recognition may be performed on each sub-voice signal according to the sub-voice embedded representation feature and the embedded representation feature of each contrastive word to obtain a sub-voice recognition result; and finally a voice recognition result corresponding to the to-be-recognized voice signal may be determined according to the sub-voice recognition result of each sub-voice signal. In this way, the embedded feature representation system formed by the first-stage feature extraction network and the second-stage feature extraction network performs a voice feature extraction on each sub-voice signal, so that sub-voice embedded representation features of sub-voice signals may be accurately extracted, and the to-be-recognized voice signal may be accurately recognized based on the sub-voice embedded representation features.

One or more aspects of an example application of an electronic device is described below. The electronic device may be a voice recognition device. The voice recognition device may be implemented as a terminal, or may be implemented as a server. In an implementation, the voice recognition device may be implemented as a notebook computer, a tablet computer, a desktop computer, a mobile device (for example, a mobile phone, a portable music player, a personal digital assistant, a dedicated message device, or a portable game device), a smart robot, a smart home appliance, a smart in-vehicle device or any other terminal having a voice data processing function and a game application running function. In another implementation, the voice recognition device may be implemented as a server. The server may be an independent physical server, or may be a server cluster or distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and/or a big data and artificial intelligence platform. The terminal and the server may be directly or indirectly connected in a wired or wireless communication manner. An example of the electronic device being implemented as a server is described below.

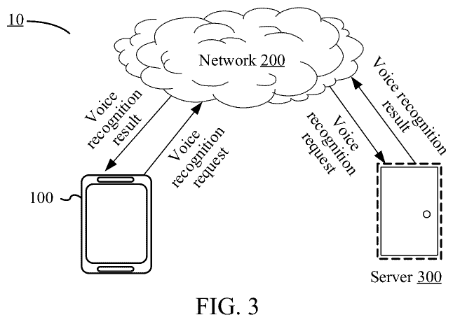

FIG. 3 is an schematic architectural diagram of one or more aspects of an example of a voice recognition system. An example in which a voice recognition method is applied to a game application is used for description purposes only and use of the voice recognition method is not limited to game applications. To support any game application and detect and recognize a voice of a player in a running process of the game application, the game application may be at least installed on a terminal. A voice recognition system 10 may include a terminal 100, a network 200, and a server 300. The server 300 may be an application server of the game application. The server 300 may form the electronic device. The terminal 100 may be connected to the server 300 by the network 200. The network 200 may be a wide area network, a local area network, or a combination of the two. During running of the game application, the terminal 100 may run the game application and may generate game voice data. The game voice data may comprise a game running voice and a voice of speech and communication between players. After acquiring the game voice data, the terminal 100 may encapsulate the game voice data as a to-be-recognized voice signal into a voice recognition request, and may transmit the voice recognition request to the server 300 through the network 200 to request the server 300 to perform a voice recognition on the game voice data to determine whether the game voice data contains a first type of content, such as foul language or inappropriate language. After receiving the voice recognition request, the server 300 may perform a sliding window interception on the to-be-recognized voice signal in response to the voice recognition request to obtain two sub-voice signals. The server 300 may perform a voice feature extraction on each sub-voice signal through a pre-trained embedded feature representation system to obtain a sub-voice embedded representation feature of the corresponding sub-voice signal. The server 300 may acquire an embedded representation feature of each contrastive word in a preset contrastive word library. The server 300 may perform a voice recognition on each sub-voice signal according to the sub-voice embedded representation feature and the embedded representation feature of each contrastive word to obtain a sub-voice recognition result. The server 300 may determine a voice recognition result corresponding to the to-be-recognized voice signal according to the sub-voice recognition results of at least two sub-voice signals. After obtaining the voice recognition result, the voice recognition result may be transmitted to the terminal 100 by server 300. The terminal 100 may generate corresponding prompt information based on the voice recognition result and display the prompt information.

In one instance, the voice recognition process may be implemented by the terminal 100. To be specific, after acquiring game voice data, the terminal may perform a voice recognition on the game voice data as a to-be-recognized voice signal, i.e., the terminal may perform a sliding window interception on the to-be-recognized voice signal to obtain at least two sub-voice signals. The terminal may perform a voice feature extraction on each sub-voice signal through a pre-trained embedded feature representation system to obtain a sub-voice embedded representation feature. The terminal may acquire an embedded representation feature of each contrastive word in a preset contrastive word library. The terminal may perform a voice recognition on each sub-voice signal according to the sub-voice embedded representation feature and the embedded representation feature of each contrastive word to obtain a sub-voice recognition result. The terminal may determine a voice recognition result corresponding to the to-be-recognized voice signal according to the sub-voice recognition results of at least two sub-voice signals.

The voice recognition method may be implemented based on a cloud platform through a cloud technology. For example, the server 300 may be a cloud server. The cloud server may perform a sliding window interception on the to-be-recognized voice signal, the cloud server may perform a voice feature extraction on each sub-voice signal to obtain a sub-voice embedded representation feature, the cloud server may acquire an embedded representation feature of each contrastive word in a preset contrastive word library, the cloud server may perform a voice recognition on each sub-voice signal according to the sub-voice embedded representation feature and the embedded representation feature of each contrastive word, the cloud server may determine a voice recognition result corresponding to the to-be-recognized voice signal according to the sub-voice recognition results of at least two sub-voice signals, or the like.

In some instances, a cloud memory may be further provided, and the to-be-recognized voice signal may be stored in the cloud memory, the pre-trained embedded feature representation system may be stored in the cloud memory, parameters of the embedded feature representation system may be stored in the cloud memory, the preset contrastive word library may be stored in the cloud memory, the sub-voice recognition result may be stored in the cloud memory, the voice recognition result may be stored in the cloud memory, and/or the like may be stored in the cloud memory. In this way, in a process of running the game application, the pre-trained embedded feature representation system, the parameters of the embedded feature representation system, and/or the preset contrastive word library may be directly acquired from the cloud memory to perform a voice recognition on the to-be-recognized voice signal. In this way, the reading efficiency of data may be greatly improved, thereby improving the efficiency of a voice recognition method.

The cloud technology may be a hosting technology that unifies a series of resources such as hardware, software, and networks in a wide area network or a local area network to implement computing, storage, processing, and sharing of data. The cloud technology may be a collective name of a network technology, an information technology, an integration technology, a management platform technology, an application technology, and/or the like based on an application of a cloud computing business mode, and may form a resource pool, which is used as required, and is flexible and convenient. The cloud computing technology becomes an important support. A background service of a technical network system requires a large amount of computing and storage resources, such as video websites, image websites, and more portal websites. As the Internet industry is highly developed and applied, each article may have its own identifier in the future and needs to be transmitted to a background system for logical processing. Data at different levels is separately processed, and data in various industries requires strong system support, which can only be implemented through cloud computing.

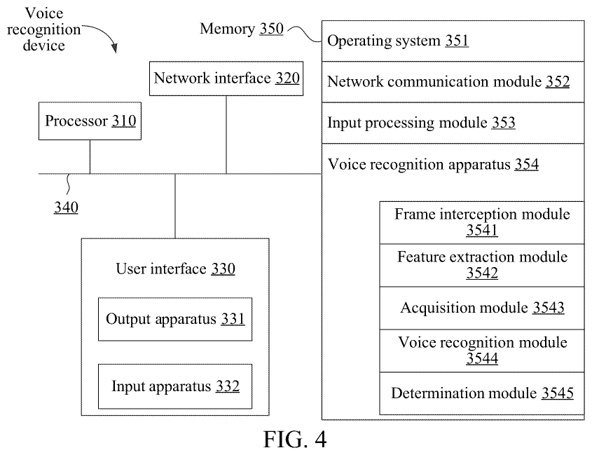

FIG. 4 is a schematic structural diagram of one or more aspects of an example electronic device. The electronic device in FIG. 4 may be a voice recognition device. The electronic device may include at least one processor 310, a memory 350, at least one network interface 320, and/or a user interface 330. The components in the electronic device may be coupled by a bus system 340. The bus system 340 may be configured to implement connection and communication between the components. In addition to a data bus, the bus system 340 may further include a power bus, a control bus, and/or a status signal bus. However, for case of clear description, all types of buses in FIG. 4 are marked as the bus system 340.

The processor 310 may be an integrated circuit chip having a signal processing capability, for example, a general purpose processor, a DSP, or another PLD, discrete gate, transistor logical device, or discrete hardware component. The general purpose processor may be a microprocessor, any conventional processor, or the like.

The user interface 330 may include one or more output apparatuses 331 that enable the presentation of media content and one or more input apparatuses 332.

The memory 350 may be a removable memory, a non-removable memory, or a combination thereof. An exemplary hardware device may include a solid-state memory, a hard disk drive, an optical disk drive, and/or the like. The memory 350 may include one or more storage devices having physical locations located at least a threshold distance from the processor 310. The memory 350 may include a volatile memory or a non-volatile memory, or may include a volatile memory and a non-volatile memory. The non-volatile memory may be a read-only memory (ROM), and the volatile memory may be a random access memory (RAM). The memory 350 may include any suitable type of memories. The memory 350 may store data to support various operations. Examples of the data include but are not limited to a program, a module, a data structure, or a subset or superset thereof.

An operating system 351 may include system programs configured for processing various basic system services and performing hardware-related tasks, for example, a framework layer, a kernel library layer, and a driver layer, and may be configured to implement various basic services and process hardware-based tasks. A network communication module 352 may be configured to reach another computing device through one or more (wired or wireless) network interfaces 320. An exemplary network interface 320 may include Bluetooth, wireless fidelity (Wi-Fi), a universal serial bus (USB), and/or the like. An input processing module 353 may be configured to detect one or more user inputs or interactions from the one or more input apparatuses 332 and translate the detected input or interaction.

The apparatus may be implemented in a software manner. FIG. 4 shows a voice recognition apparatus 354 stored in the memory 350. The voice recognition apparatus 354 may be a voice recognition apparatus in the electronic device, and may be software in a form of a program, a plug-in, or the like, and may include the following software modules: a frame interception module 3541, a feature extraction module 3542, an acquisition module 3543, a voice recognition module 3544, and a determination module 3545. These modules are logical modules, and therefore may be combined or further split in any manner according to functions to be implemented. The functions of the modules are described below.

The apparatus may be implemented in a hardware manner. In an example, the apparatus may be a processor in the form of a hardware decoding processor, and may be programmed to perform the voice recognition method. For example, the processor in the form of a hardware decoding processor may use one or more application-specific integrated circuits (ASIC), a DSP, a programmable logic device (PLD), a complex PLD (CPLD), a field programmable gate array (FPGA), or another electronic element.

The voice recognition method may be performed by an electronic device. The electronic device may be any terminal having a voice data processing function, or may be a server. In other words, the voice recognition method may be performed by a terminal, may be performed by a server, or may be performed by a terminal or a server through interaction.

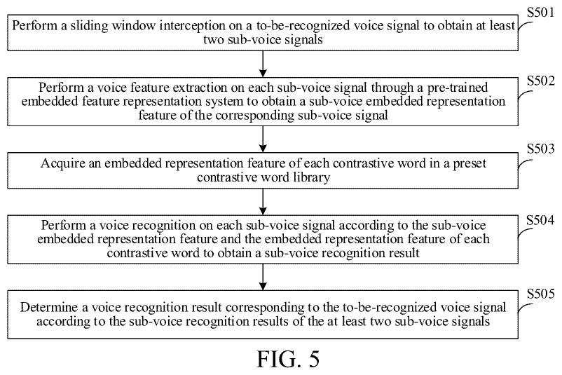

FIG. 5 is a schematic flowchart of one or more aspects of an example of a voice recognition method The voice recognition method in FIG. 5 is described through an example in which a server is an execution entity, and includes the following Operation S501 to Operation S505.

Operation S501: Perform a sliding window interception on a to-be-recognized voice signal to obtain at least two sub-voice signals.

The to-be-recognized voice signal may be a voice signal corresponding to a game voice in a game scenario. The game voice may be collected in a process of running a game application, and the voice signal may be extracted from the game voice to obtain the to-be-recognized voice signal.

The method may be applied to a voice recognition scenario of a specific type in a game voice. The voice recognition scenario of the specific type may be determined according to an actual voice recognition task. In other words, the voice recognition scenario of the specific type may be a voice recognition scenario of any type, for example, a foul language recognition scenario, an inappropriate language recognition scenario, a game language recognition scenario, a game intensity recognition scenario, or the like.

The foul language recognition scenario is used as an example to describe an application scenario. In a process of running a game application, because players may have a voice conversation, to ensure that the game can run in a positive and healthy environment, it may be determined in real time whether content of a first type, such as foul language or inappropriate language, exists in a voice of a player during game playing to discover inappropriate language of the player in time and make a timely prompt to the player, thereby ensuring positive running of the game. Content of a first type, such as foul language or inappropriate language recognition may be implemented by using the voice recognition method. To be specific, a voice between players may be used as a to-be-recognized voice, and recognition of content of the first type, such as foul language or inappropriate language, may be performed on the to-be-recognized voice by using the voice recognition method to determine whether foul language or inappropriate language exists in the voice between the players.

The to-be-recognized voice signal may include a conversation voice of a player, and may include a game running voice in a game running scenario. The game running voice may include, but is not limited to, a voice during skill casting, a special effect voice, a voice uttered by a virtual hero, and/or a voice generated in use of any item. In other words, a game running voice in a game running environment may be acquired through a game engine, and a conversation voice of a player may be acquired by a voice collection apparatus on a terminal, and then the game running voice and the conversation voice may be superimposed to form the to-be-recognized voice.

The sliding window interception may be traversing the to-be-recognized voice signal through a sliding window with a preset step, and a sub-voice signal with the same step as the sliding window may be intercepted each time.

In an implementation, each time a sub-voice signal is intercepted, a voice recognition may be performed on the sub-voice signal by using subsequent operations to obtain a sub-voice recognition result. Then, another sub-voice signal may be obtained through a sliding window interception, and a voice recognition may continue to be performed on the sub-voice signal. This process may be repeated until a voice recognition process of every sub-voice signal in the to-be-recognized voice signal is completed.

In another implementation, in a process of performing a plurality of sliding window interceptions on the to-be-recognized voice signal, a plurality of sub-voice signals may be correspondingly obtained, and a recognition identifier may be added to each sub-voice signal in a sequential order of the sub-voice signals in the to-be-recognized voice signal. The recognition identifier may be configured for distinguishing the sub-voice signal from other sub-voice signals, and the recognition identifier may further recognize relative sequential positions of the sub-voice signal and the other sub-voice signals in the to-be-recognized voice signal. After the plurality of sub-voice signals are obtained, based on the recognition identifier of each sub-voice signal, a voice recognition may be sequentially performed on each sub-voice signal according to the relative sequential positions of the sub-voice signals in the to-be-recognized voice signal to correspondingly obtain a plurality of sub-voice recognition results.

When the sliding window interception is performed to obtain a sub-voice signal, two sub-voice signals obtained in two adjacent interception processes may be two adjacent signal segments in the to-be-recognized voice signal. In other words, when the sliding window interception is performed to obtain a sub-voice signal, the interception may be sequentially performed from a signal start position of the to-be-recognized voice signal, so that no signal segment of the to-be-recognized voice signal is lost during the interception.

Operation S502: Perform a voice feature extraction on each sub-voice signal through a pre-trained embedded feature representation system to obtain a sub-voice embedded representation feature of the corresponding sub-voice signal.

The embedded feature representation system may include a first-stage feature extraction network and a second-stage feature extraction network. The first-stage feature extraction network may be configured to perform a first-stage voice feature extraction on the sub-voice signal. The second-stage feature extraction network may be configured to perform a second-stage voice feature extraction on the sub-voice signal based on a first-stage voice feature obtained in the first-stage voice feature extraction. A feature extraction precision of the second-stage voice feature extraction may be greater than a feature extraction precision of the first-stage voice feature extraction.

Each sub-voice signal may be inputted into the embedded feature representation system. The first-stage feature extraction network and the second-stage feature extraction network in the embedded feature representation system may sequentially perform the first-stage voice feature extraction and the second-stage voice feature extraction on the sub-voice signal, in other words, sequentially perform a voice feature extraction with a coarse precision and a voice feature extraction with a fine precision on the sub-voice signal to obtain the sub-voice embedded representation feature, wherein the fine precision is more precise than the coarse precision.

The sub-voice embedded representation feature may be a feature representation (usually in a vector form) of a fixed size obtained by performing a data conversion on the sub-voice signal. The sub-voice embedded representation feature may facilitate subsequent processing and calculation. In a process of implementation, the sub-voice embedded representation feature may be obtained in a manner of feature embedding. The feature embedding may be converting (for example, performing a dimension reduction on) inputted data into a feature representation (in a vector form) of a fixed size to facilitate processing and calculation (for example, distance calculation). For example, for a model of training voice signals for speaker recognition, a voice segment may be converted into a digital vector, and a distance (for example, a Euclidean distance) between another voice segment from the same speaker and the digital vector obtained through the conversion may be enabled to be small. For example, the distance between the another voice segment from the same speaker and the digital vector obtained through the conversion is enabled to be less than a preset distance threshold. The feature embedding may perform a dimension reduction on an input feature. A manner of the dimension reduction may be performing full connection processing by using one fully connected layer and then performing a weight matrix calculation, thereby implementing a process of reducing a dimension.

The first-stage feature extraction network may be an unsupervised pre-trained model, and the first-stage feature extraction network may perform a self-supervised pre-training based on large-scale unannotated voices in advance to obtain a trained first-stage feature extraction network. The second-stage feature extraction network may be a model obtained by performing a feature extraction based on the trained first-stage feature extraction network and then performing a model training. In a process of implementation, the foregoing voice feature extraction with the coarse precision (i.e., the feature extraction precision during the first-stage voice feature extraction) may be performed on a single-word voice in a single-word voice data set through the trained first-stage feature extraction network to obtain an embedded representation feature of the single-word voice, and then the embedded representation feature of the single-word voice may be inputted as an input feature of the second-stage feature extraction network into the second-stage feature extraction network. The voice feature extraction with the fine precision (i.e., the feature extraction precision during the second-stage voice feature extraction) is performed on the single-word voice through the second-stage feature extraction network. Training processes of the first-stage feature extraction network, the second-stage feature extraction network, and the embedded feature representation system are described below in detail.

When the voice feature extraction is performed on the sub-voice signal, the sub-voice signal may be directly inputted into the embedded feature representation system to perform the feature extraction so that the embedded representation feature of the sub-voice signal may extracted, and it may not be necessary to extract a Mel feature of the sub-voice signal. In this way, a calculation amount of the model may be greatly reduced, and the extracted embedded representation feature may express voice information in the sub-voice signal more accurately. Therefore, an accurate voice feature extraction may be performed on the sub-voice signal.

Each sub-voice signal of the at least two sub-voice signals may be sequentially inputted into the pre-trained embedded feature representation system. The pre-trained embedded feature representation system may perform a voice feature extraction on each sub-voice signal to obtain a plurality of sub-voice embedded representation features.

The feature extraction precision may be configured for reflecting an accuracy that an extracted embedded representation feature may reflect a corresponding sub-voice signal in a process of the voice feature extraction. For a process of the voice feature extraction with the coarse precision, the extracted embedded representation feature may reflect a small amount of information of a corresponding sub-voice signal (for example, an amount of information of the corresponding sub-voice signal that the extracted embedded representation feature can reflect may be less than an information amount threshold), and therefore an accuracy of information of the corresponding sub-voice signal that the extracted embedded representation feature may reflect is less than an accuracy threshold. For a process of the voice feature extraction with the fine precision, the extracted embedded representation feature can reflect a large amount of information of a corresponding sub-voice signal (for example, an amount of information of the corresponding sub-voice signal that the extracted embedded representation feature may reflect may be greater than or equal to the information amount threshold), and therefore the accuracy of information of the corresponding sub-voice signal that the extracted embedded representation feature may reflect is greater than the accuracy threshold.

Operation S503: Acquire an embedded representation feature of each contrastive word in a preset contrastive word library.

The preset contrastive word library may include a plurality of contrastive words. The contrastive words in the preset contrastive word library may have specific attribute information. In other words, the contrastive words in the preset contrastive word library may be words of a specific type, i.e. the first content type. For example, when a foul language recognition is to be performed on the to-be-recognized voice signal, the contrastive words in the preset contrastive word library may be foul language words collected and stored in advance. In other words, the preset contrastive word library may be a foul word library. When a commendation word recognition is to be performed on the to-be-recognized voice signal, the contrastive words in the preset contrastive word library are commendation words collected and stored in advance. In other words, the preset contrastive word library may be a commendation word library. When a game instruction recognition is to be performed on the to-be-recognized voice signal, the contrastive words in the preset contrastive word library may be game instruction-related words collected and stored in advance. In other words, the preset contrastive word library may be a game instruction word library.

The preset contrastive word library may store a contrastive word voice or a contrastive word voice signal of each contrastive word. A voice signal recognition may be performed on the contrastive word voice to obtain the contrastive word voice signal corresponding to the contrastive word voice, and the voice feature extraction may be performed on the contrastive word voice signal to obtain the embedded representation feature of the contrastive word.

In a process of implementation, the voice feature extraction may be performed on the contrastive word voice signal of each contrastive word in the preset contrastive word library by using the pre-trained embedded feature representation system to obtain the embedded representation feature of each contrastive word, i.e., the embedded representation feature of each contrastive word voice signal.

Operation S504: Perform a voice recognition on each sub-voice signal according to the sub-voice embedded representation feature and the embedded representation feature of each contrastive word to obtain a sub-voice recognition result.

The sub-voice embedded representation feature may be compared with the embedded representation feature of the contrastive word to obtain the sub-voice recognition result. During comparison, a cosine similarity between the sub-voice embedded representation feature and the embedded representation feature of the contrastive word may be calculated, and the sub-voice recognition result may be determined based on the cosine similarity. A cosine similarity between the sub-voice embedded representation feature of each sub-voice signal and the embedded representation feature of each contrastive word may be calculated.

The performing a voice recognition on each sub-voice signal according to the sub-voice embedded representation feature and the embedded representation feature of each contrastive word to obtain a sub-voice recognition result may include, but is not limited to one or more of the following scenarios.

For each sub-voice signal, after the cosine similarity between the sub-voice embedded representation feature of the sub-voice signal and the embedded representation feature of each contrastive word is obtained, the contrastive word may be sorted based on the cosine similarity to form a contrastive word sequence; then first N contrastive words in the contrastive word sequence may be extracted, N being an integer greater than 1; and finally, cosine similarities between the sub-voice embedded representation feature of sub-voice signal and the embedded representation features of the first N contrastive words may be compared, and if the N cosine similarities are all greater than a similarity threshold, it may be determined that a sub-voice corresponding to the sub-voice signal comprises a voice word having the same attribute as a contrastive word in the preset contrastive word library. The first N contrastive words may be selected after the contrastive word sequence is formed based on the cosine similarities, and N may be far less than a total quantity of all the contrastive words in the preset contrastive word library. Therefore, during comparison with the similarity threshold, it may be only necessary to perform a comparison to determine whether the N cosine similarities are greater than the similarity threshold, so that a data calculation amount of data comparison is greatly reduced, thereby improving the efficiency of the voice recognition method. Because N may be greater than 1, in a case that the cosine similarities of the plurality of contrastive words are all greater than the similarity threshold, it may be determined that a sub-voice signal contains a voice word having the same attribute as a contrastive word in the preset contrastive word library. In this way, a recognition and a verification may be performed based on the cosine similarities of the plurality of contrastive words, so that the accuracy of the voice recognition can be ensured, thereby avoiding an impact on the accuracy of a voice recognition result in which an error exists in the calculation of a cosine similarity of a single contrastive word.

For each sub-voice signal, after the cosine similarity between the sub-voice embedded representation feature of the sub-voice signal and the embedded representation feature of each contrastive word is obtained, a preset similarity threshold may be acquired; and then all contrastive words having a cosine similarity greater than the similarity threshold may be selected, a quantity of all the contrastive words may be acquired, and when the quantity of all the contrastive words is greater than a quantity threshold, it may be determined that a sub-voice corresponding to the sub-voice signal contains a voice word having the same attribute as a contrastive word in the preset contrastive word library. Through the double determination of the similarity threshold and the quantity threshold, in a case that a high cosine similarity is ensured, a case of a large quantity of similar contrastive words may be determined. In other words, a large quantity of contrastive words having a high cosine similarity with the sub-voice embedded representation feature of the sub-voice signal may be in the preset contrastive word library. In this way, based on the double determination of the two thresholds, it may be accurately determined whether the sub-voice corresponding to the sub-voice signal contains a voice word having the same attribute as a contrastive word in the preset contrastive word library.

For each sub-voice signal, the cosine similarity between the sub-voice embedded representation feature of the sub-voice signal and the embedded representation feature of each contrastive word may be sequentially calculated, and after one cosine similarity is calculated each time, a determination may be performed on the cosine similarity, to determine whether the cosine similarity is greater than the similarity threshold. As long as it is determined that a cosine similarity between the sub-voice embedded representation feature of the sub-voice signal and the embedded representation feature of any contrastive word is greater than the similarity threshold, the calculation of cosine similarities between the sub-voice embedded representation feature of the sub-voice signal and embedded representation features of the remaining contrastive words may be stopped, and it may be determined that a sub-voice corresponding to the sub-voice signal comprises a voice word having the same attribute as a contrastive word in the preset contrastive word library. It may be predefined that as long as a cosine similarity between an embedded representation feature of at least one contrastive word and the sub-voice embedded representation feature is greater than the similarity threshold, it is determined that the sub-voice corresponding to the sub-voice signal comprises a voice word having the same attribute as a contrastive word in the preset contrastive word library. In other words, as long as it is detected that a cosine similarity between the embedded representation feature of one contrastive word and the sub-voice embedded representation feature is greater than the similarity threshold, it may be determined that the sub-voice corresponding to the sub-voice signal contains a voice word having the same attribute as a contrastive word in the preset contrastive word library. A determination may be performed while a cosine similarity is calculated. Once it is determined that a calculated cosine similarity is greater than the similarity threshold, the calculation of a cosine similarity of another contrastive word may be stopped. In this way, the efficiency of a detection can be greatly improved, thereby improving the efficiency of the voice recognition method.

For each sub-voice signal, a counter may be first initialized to 0; and then the cosine similarity between the sub-voice embedded representation feature of the sub-voice signal and the embedded representation feature of each contrastive word may be sequentially calculated, and after one cosine similarity is calculated each time, a determination may be performed on the cosine similarity, to determine whether the cosine similarity is greater than the similarity threshold. As long as it is determined that a cosine similarity between the sub-voice embedded representation feature of the sub-voice signal and the embedded representation feature of any contrastive word is greater than the similarity threshold, the counter may be increased by 1. This process may be repeated, and when a count value of the counter is greater than or equal to a value threshold, the calculation of cosine similarities between the sub-voice embedded representation feature of the sub-voice signal and embedded representation features of the remaining contrastive words may be stopped, and it may be determined that a sub-voice corresponding to the sub-voice signal comprises a voice word having the same attribute as a contrastive word in the preset contrastive word library. The value threshold is an integer greater than 1 Determination results may be counted by using the counter. To be specific, after one cosine similarity is calculated each time and a determination is performed on the cosine similarity and the similarity threshold, the counter may be updated based on a determination result (to be specific, if a condition that the cosine similarity is greater than the similarity threshold is met, the counter may be increased by 1; and if the condition that the cosine similarity is greater than the similarity threshold is not met, the value of the counter remains unchanged). This manner has multiple beneficial effects. Through the double determination of the similarity threshold and the value threshold, in a case that a high cosine similarity is ensured, a case of a large quantity of similar contrastive words may be determined, so that a case that a large quantity of contrastive words having a high cosine similarity with the sub-voice embedded representation feature of the sub-voice signal exist in the preset contrastive word library can be accurately recognized. Because a determination and the counting of the counter are performed once when one cosine similarity is calculated each time, once the count value of the counter is greater than or equal to the value threshold, the calculation of the cosine similarity is stopped. In other words, it is not necessary to calculate a cosine similarity between the sub-voice embedded representation feature and the embedded representation feature of each contrastive word in the preset contrastive word library, so that a data calculation amount of calculating a cosine similarity may be greatly reduced, thereby improving the efficiency of the voice recognition method.

Operation S505: Determine a voice recognition result corresponding to the to-be-recognized voice signal according to the sub-voice recognition results of the at least two sub-voice signals.

After the sub-voice recognition result of each sub-voice signal is obtained, comprehensive result processing may be performed on the sub-voice recognition results of the at least two sub-voice signals to obtain the voice recognition result corresponding to the to-be-recognized voice signal.

During the comprehensive result processing, when a cosine similarity between the sub-voice embedded representation feature and the embedded representation feature of any contrastive word is greater than the similarity threshold, it may be determined that the sub-voice recognition result of the sub-voice signal is a specific recognition result, in other words, it is determined that a sub-voice corresponding to the sub-voice signal comprises a voice word having the same attribute as a contrastive word in the preset contrastive word library (i.e. of the same content type). Alternatively, when cosine similarities between the sub-voice embedded representation feature and embedded representation features of a preset quantity of contrastive words are greater than the similarity threshold, it may be determined that the sub-voice recognition result of the sub-voice signal is a specific recognition result, in other words, it is determined that a sub-voice corresponding to the sub-voice signal contains a voice word having the same attribute as a contrastive word in the preset contrastive word library.

In the voice recognition method, the pre-trained embedded feature representation system may perform a voice feature extraction on each sub-voice signal obtained by performing a sliding window interception to obtain a sub-voice embedded representation feature; may perform a voice recognition on each sub-voice signal according to the sub-voice embedded representation feature and an embedded representation feature of each contrastive word in a preset contrastive word library to obtain a sub-voice recognition result; and may determine a voice recognition result corresponding to a to-be-recognized voice signal according to sub-voice recognition results of at least two sub-voice signals. In this way, the embedded feature representation system formed by the first-stage feature extraction network and the second-stage feature extraction network may perform a voice feature extraction on each sub-voice signal, so that sub-voice embedded representation features of sub-voice signals may be accurately extracted, and the to-be-recognized voice signal may be accurately recognized based on the sub-voice embedded representation features.

A voice recognition system may include a terminal and a server. The voice recognition method may be used to perform a voice recognition on game voice data generated in a process of running a game application, to determine whether language (for example, foul language or inappropriate language) of a specific type exists in the game voice data; or may be used to perform a voice recognition on an eSports voice generated in an eSports scenario, to determine whether foul language or inappropriate language exists in the eSports voice; or may be used to perform a voice recognition on a short video voice in a short video in a short video scenario, to determine whether foul language or inappropriate language exists in the short video voice; or certainly may be applied to another similar scenario in which a voice exists and a voice recognition needs to be performed.

The game application may be run on the terminal, the game voice data may be collected in a process of running the game application, and a voice signal corresponding to the game voice data may be acquired to obtain the to-be-recognized voice signal, so that a voice recognition may be performed on the to-be-recognized voice signal by using the voice recognition method.

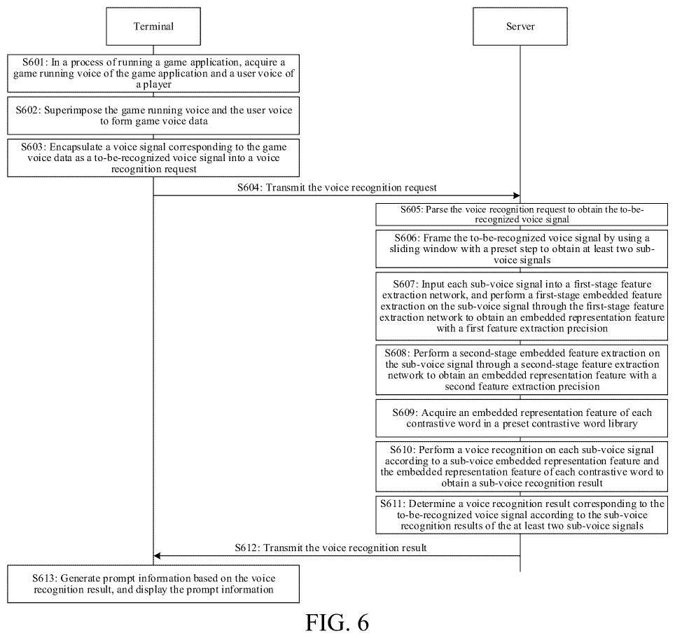

FIG. 6 is a schematic flowchart of one or more aspects of a voice recognition method. As shown in FIG. 6, the method includes the following Operation S601 to Operation S613.

Operation S601: In a process of running a game application, a terminal acquires a game running voice of the game application and a user voice of a player.

In the process of running the game application by the terminal, the game running voice of the game application may be acquired. The game running voice includes, but is not limited to, a voice during skill casting, a special effect voice, a voice uttered by a virtual hero, and a voice generated in use of any item. The game running voice may be directly acquired through a game engine.

In the process of running the game application by the terminal, a voice collection apparatus on the terminal may collect a conversation voice of the player. In other words, the user voice may be acquired. The user voice may be a voice of speech and/or communication between players in the process of running the game. The user voice may include only a voice of the current player, or may include voices of multiple players in a current game scenario.

Operation S602: The terminal superimposes the game running voice and the user voice to form game voice data.

The game running voice and the user voice may be superimposed in a time dimension. The game running voice and the user voice may be combined into a segment of combined game voice data on a time axis. The game voice data may include both the game running voice and the user voice.

Operation S603: The terminal encapsulates a voice signal corresponding to the game voice data as a to-be-recognized voice signal into a voice recognition request.

Operation S604: The terminal transmits the voice recognition request to a server.

Operation S605: The server parses the voice recognition request to obtain the to-be-recognized voice signal.

Operation S606: The server frames the to-be-recognized voice signal by using a sliding window with a preset step to obtain at least two sub-voice signals, the at least two sub-voice signals having the same frame length.

The to-be-recognized voice signal may be traversed by using the sliding window with the preset step, and a sub-voice signal with the same step as the sliding window is intercepted each time. In other words, the original to-be-recognized voice signal may be segmented into a plurality of sub-voice signals with a fixed size. Each sub-voice signal may be referred to as one frame. The frame length usually ranges from 10 ms to 30 ms though the voice recognition method is not limited to such a frame length. All the sub-voice signals may be connected to form the original to-be-recognized voice signal.

When performing a plurality of sliding window interceptions on the to-be-recognized voice signal, a plurality of sub-voice signals may be correspondingly obtained, and a recognition identifier may be added to each sub-voice signal in a sequential order of the sub-voice signals in the to-be-recognized voice signal. The recognition identifier may be configured for distinguishing the sub-voice signal from other sub-voice signals, and the recognition identifier may further recognize relative sequential positions of the sub-voice signal and the other sub-voice signals in the to-be-recognized voice signal.

After the to-be-recognized voice signal is framed, a preset window function may be acquired, and each sub-voice signal may be smoothed by using the preset window function to correspondingly obtain at least two smoothed sub-voice signals. The smoothing may also be referred to as windowing. After the to-be-recognized voice signal is framed, to implement smooth transition between frames, the windowing keeps the continuity between adjacent frames, in other words, eliminates signal discontinuity that may be caused at two ends of each frame, i.e., spectral leakage. The spectral leakage is reduced through the preset window function, and the preset window function can reduce an impact caused by truncation.

Each frame may be introduced into the preset window function to form a windowed voice signal. For example, sw(n)=s(n)*w(n). sw(n) may be the windowed voice signal, i.e., a smoothed sub-voice signal, wherein s(n) may be each frame, i.e., each sub-voice signal, and w(n) may be the preset window function. The preset window function may include a rectangular window and/or a Hamming window.

When a voice feature extraction is performed on each sub-voice signal subsequently, the voice feature extraction may be performed on each smoothed sub-voice signal. In other words, subsequent voice recognition operations may be performed based on the smoothed sub-voice signal.

Operation S607: The server inputs each sub-voice signal into a first-stage feature extraction network, and performs a first-stage embedded feature extraction on the sub-voice signal through the first-stage feature extraction network to obtain an embedded representation feature with a first feature extraction precision.

Operation S608: The server inputs the embedded representation feature with the first feature extraction precision into a second-stage feature extraction network, and performs a second-stage embedded feature extraction on the sub-voice signal through the second-stage feature extraction network to obtain an embedded representation feature with a second feature extraction precision, the first feature extraction precision being less than the second feature extraction precision.

An embedded feature representation system may be the first-stage feature extraction network and the second-stage feature extraction network. The first-stage feature extraction network may be configured to perform a first-stage voice feature extraction on the sub-voice signal. The second-stage feature extraction network may be configured to perform a second-stage voice feature extraction on the sub-voice signal based on a first-stage voice feature obtained in the first-stage voice feature extraction. A feature extraction precision of the second-stage voice feature extraction may be greater than a feature extraction precision of the first-stage voice feature extraction. The feature extraction precision may be configured for reflecting an accuracy that an extracted embedded representation feature reflects a corresponding sub-voice signal in a process of the voice feature extraction.

The first-stage feature extraction network may be an unsupervised pre-trained model, and the first-stage feature extraction network may perform a self-supervised pre-training based on large-scale unannotated voices in advance to obtain a trained first-stage feature extraction network. The second-stage feature extraction network may be a model obtained by performing a feature extraction based on the trained first-stage feature extraction network and then performing a model training.

The embedded representation feature with the second feature extraction precision may form a sub-voice embedded representation feature of the corresponding sub-voice signal.

Operation S609: The server acquires an embedded representation feature of each contrastive word in a preset contrastive word library.

The preset contrastive word library may include a plurality of contrastive words. The contrastive words in the preset contrastive word library may have attribute information. For example, the contrastive words in the preset contrastive word library are words of a particular content type. The preset contrastive word library may include a contrastive word voice signal of each contrastive word. The voice feature extraction may be performed on the contrastive word voice signal of each contrastive word through a pre-trained embedded feature representation system to obtain the embedded representation feature of each contrastive word.

Operation S610: The server performs a voice recognition on each sub-voice signal according to a sub-voice embedded representation feature and the embedded representation feature of each contrastive word to obtain a sub-voice recognition result.

The performing a voice recognition on each sub-voice signal may be implemented in the following manner:

A similarity (which may be, for example, a cosine similarity) between the sub-voice embedded representation feature and the embedded representation feature of each contrastive word may be determined. When it is determined that a similarity between the sub-voice embedded representation feature and the embedded representation feature of any contrastive word is greater than a similarity threshold, it may be determined that the sub-voice recognition result of the sub-voice signal is a specific recognition result. The specific recognition result indicates that a sub-voice corresponding to the sub-voice signal contains a voice word having the same attribute as a contrastive word in the preset contrastive word library. In other words, the specific recognition result indicates that a sub-voice corresponding to the sub-voice signal contains a specific voice word, the specific voice word being a voice word having the same attribute as a contrastive word in the preset contrastive word library (i.e., of the same content type).

For example, when the contrastive words in the preset contrastive word library are foul language words collected and stored in advance, if the sub-voice recognition result of the sub-voice signal is the specific recognition result, it may be determined that the sub-voice corresponding to the sub-voice signal contains foul language words. When the contrastive words in the preset contrastive word library are commendation words collected and stored in advance, if the sub-voice recognition result of the sub-voice signal is the specific recognition result, it may be determined that the sub-voice corresponding to the sub-voice signal contains commendation words. When the contrastive words in the preset contrastive word library may be game instruction-related words collected and stored in advance, if the sub-voice recognition result of the sub-voice signal is the specific recognition result, it may be determined that the sub-voice corresponding to the sub-voice signal contains game instructions.

Operation S611: The server determines a voice recognition result corresponding to the to-be-recognized voice signal according to the sub-voice recognition results of the at least two sub-voice signals.

When a sub-voice recognition result of any sub-voice signal is the specific recognition result, it may be determined that the voice recognition result corresponding to the to-be-recognized voice signal is the specific recognition result. Alternatively, when sub-voice recognition results of a preset quantity of sub-voice signals are the specific recognition result, it may be determined that the voice recognition result corresponding to the to-be-recognized voice signal is the specific recognition result, the preset quantity being an integer greater than 1.

Operation S612: The server transmits the voice recognition result to the terminal.

Operation S613: The terminal may generate prompt information based on the voice recognition result, and may display the prompt information.

When the voice recognition result is that a to-be-recognized voice contains a voice word having the same attribute as a contrastive word in the preset contrastive word library, the prompt information corresponding to the voice recognition result may be generated, and the prompt information may be displayed to prompt the player.

The prompt information may be displayed in the form of a pop-up window, or the prompt information may be displayed in a current game interface. The prompt information may be presented in the form of a text, presented in the form of a special effect picture, or presented in the form of a special effect video or a specific prompt video. The prompt information may be outputted in the form of a voice.

For example, when it is detected that a game voice (i.e., the to-be-recognized voice signal) of a user contains a foul language word, a text prompt comprising prompt information “Mind your language, please” may be transmitted in the form of a pop-up window, or a special effect picture may be popped up in the current game interface to prompt the user to mind the language, or a foul language prompt video made in advance may be played in the current game interface to prompt the user to mind the language, or the player may be prompted through a voice.

When it is detected that a game voice of the player contains a foul language word, a penalty mechanism may be further added in the process of generating and displaying the prompt information, to further prompt the player to mind the language. The penalty mechanism may include, but is not limited to: within a time period of displaying the prompt information, the player may be kept from operating any object in the current game scenario. In other words, the player may be in a non-operable state within the time period of displaying the prompt information. The displaying of the prompt information may need to be finished before the player may enter the current game scenario again.

One or more attributes of the game voice, such as a quantity and/or severity of foul language words that a game voice currently transmitted by the player contains may be further determined. If the attribute is greater than a corresponding threshold (for example, quantity is greater than a quantity threshold or the foul language severity is greater than a severity threshold), a preset penalty mechanism may be used to impose a penalty on a game progress of the player. For example, the penalty mechanism may be prohibiting the player from transmitting a voice, prohibiting the player from continuing with a game battle, prohibiting the player from running the game application again within a duration, or the like.

In another example, the attribute may be a total quantity of foul language words contained in an entire game voice process in a current game battle of the player and/or a quantity of times of detecting a foul language word in the entire game voice process in a process of the current game battle of the player may be determined. Again, if the attribute is greater than a corresponding threshold (for example, if the total quantity is greater than a total quantity threshold or the quantity of times is greater than a quantity of times threshold), a preset penalty mechanism may be used to impose a penalty on a game progress of the player.

A display duration of the prompt information may be set. It may be preset that the display duration of the prompt information may be an initial duration. In the process of the current game battle, if the attribute value is greater than the corresponding activity threshold (for example, a quantity of times of detecting that the game voice of a player contains a foul language word is greater than the quantity of times threshold), the initial duration may be adjusted to increase the display duration of the prompt information.

An embedded feature representation system and a method for training an embedded feature representation system are described below.

The embedded feature representation system may include a first-stage feature extraction network and a second-stage feature extraction network. The first-stage feature extraction network may be configured to perform a first-stage voice feature extraction on a sub-voice signal. The second-stage feature extraction network may be configured to perform a second-stage voice feature extraction on the sub-voice signal based on a first-stage voice feature obtained in the first-stage voice feature extraction. A feature extraction precision of the second-stage voice feature extraction may be greater than a feature extraction precision of the first-stage voice feature extraction.

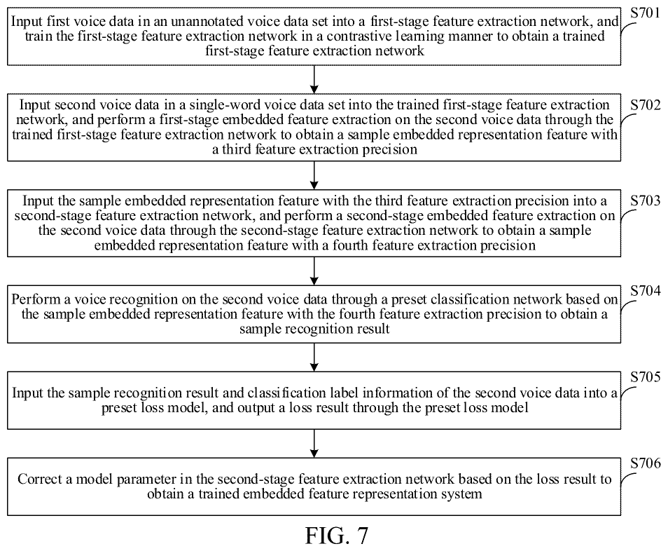

FIG. 7 is a schematic flowchart of one or more aspects of an example of a method for training an embedded feature representation system. The method for training an embedded feature representation system may be implemented by a model training module. The model training module may be a module in a voice recognition device (i.e., an electronic device). To be specific, the model training module may be a server or may be a terminal. Alternatively, the model training module may be another device independent of the voice recognition device. To be specific, the model training module may be another electronic device different from the server and the terminal that are configured to implement a voice recognition method. As shown in FIG. 7, the following Operation S701 to Operation S706 are cyclically iterated to train the embedded feature representation system until the embedded feature representation system meets a preset convergence condition and converges.

Operation S701: Input first voice data in an unannotated voice data set into a first-stage feature extraction network, and train the first-stage feature extraction network in a contrastive learning manner to obtain a trained first-stage feature extraction network.

The unannotated voice data set may include a plurality of unlabeled voice data that are not annotated. The first-stage feature extraction network may be trained in an unsupervised learning manner. Therefore, the first-stage feature extraction network may be trained by using the first voice data in the unannotated voice data set.

Contrastive learning is a self-supervised learning method. The contrastive learning may be used in a label-less case to make the first-stage feature extraction network learn which data points are similar or different to further learn general features of the unannotated voice data set. The contrastive learning allows the first-stage feature extraction network to observe which data point pairs are “similar” or “different”, to learn about higher-level features of data before a classification, a segmentation, or another task is performed. In most actual application scenarios, because labels are not set for two voice signals, to create labels, a professional needs to spend a lot of time listening to voices manually for a manual classification, segmentation, or the like. Through the contrastive learning, even if only a small part of the data set is labeled, model performance can be significantly improved.

The first-stage feature extraction network may be implemented as a wav2vec model. Through the training of the wav2vec model, a trained wav2vec model may be obtained, and actual data and an interference item sample may be distinguished through the trained wav2vec model, which can assist the wav2vec model in learning data representation forms of audio data. With these data representation forms, the wav2vec model may distinguish an accurate voice or sound from interference through editing and comparison.

Operation S702: Input second voice data in a single-word voice data set into the trained first-stage feature extraction network, and perform a first-stage embedded feature extraction on the second voice data through the trained first-stage feature extraction network to obtain a sample embedded representation feature with a third feature extraction precision.

The third feature extraction precision may be a feature extraction precision corresponding to the trained first-stage feature extraction network. To be specific, the third feature extraction precision may be a feature extraction precision of an extracted sample embedded representation feature when the trained first-stage feature extraction network performs an embedded feature extraction on the second voice data. The third feature extraction precision may correspond to the first feature extraction precision. In other words, if the first-stage embedded feature extraction is performed on the sub-voice signal by using the trained first-stage feature extraction network, the embedded representation feature with the first feature extraction precision may be obtained. If the first-stage embedded feature extraction is performed on the second voice data by using the trained first-stage feature extraction network, the embedded representation feature (the sample embedded representation feature with the third feature extraction precision) with the third feature extraction precision may be obtained.

The single-word voice data set may include a plurality of single-word voices (i.e., the second voice data), and each single-word voice may be formed by a voice of a single word. An original voice may be segmented by using a forced alignment method (Montreal forced aligner, MFA) to obtain single-word voices. An original voice signal corresponding to the original voice may be extracted, and a feature extraction may be performed on the original voice through any feature extraction network to obtain a plurality of voice features corresponding to the original voice, each voice feature being a feature vector corresponding to a voice of one word; then, the original voice signal may be made corresponding to each voice feature one by one (in other words, according to each voice feature, a starting position and an end position of a voice of a single word corresponding to the voice feature in the original voice signal may be determined), to implement an alignment between the original voice signal and the voice feature; and after the alignment is completed, the original voice signal may be segmented according to alignment positions (i.e., the starting position and the end position) between the original voice signal and the voice feature to form a plurality of sub-original voice signals, each sub-original voice signal corresponding to one single-word voice. In other words, an implementation process of the MFA technology may be first determining a sentence that a user is actually reading and then performing a forced alignment by using a determination result.

Each single-word voice in the single-word voice data set may be inputted into the trained first-stage feature extraction network, the first-stage embedded feature extraction may be performed on each single-word voice through the trained first-stage feature extraction network to obtain a plurality of sample embedded representation features, and the second-stage feature extraction network may be trained through the plurality of sample embedded representation features. In other words, the plurality of sample embedded representation features may be used as training samples of the second-stage feature extraction network to perform a model training.

Operation S703: Input the sample embedded representation feature with the third feature extraction precision into a second-stage feature extraction network, and perform a second-stage embedded feature extraction on the second voice data through the second-stage feature extraction network to obtain a sample embedded representation feature with a fourth feature extraction precision, the third feature extraction precision being less than the fourth feature extraction precision.

The fourth feature extraction precision is a feature extraction precision corresponding to the second-stage feature extraction network. To be specific, the fourth feature extraction precision may be a feature extraction precision of an extracted sample embedded representation feature when the second-stage feature extraction network performs the second-stage embedded feature extraction on the second voice data. The fourth feature extraction precision may correspond to the second feature extraction precision. In other words, if the second-stage embedded feature extraction is performed on the sub-voice signal by using the second-stage feature extraction network, the embedded representation feature with the second feature extraction precision may be obtained. If the second-stage embedded feature extraction is performed on the second voice data by using the second-stage feature extraction network, the embedded representation feature (the sample embedded representation feature with the fourth feature extraction precision) with the fourth feature extraction precision may be obtained.

The feature extraction precision of the second-stage voice feature extraction may be greater than the feature extraction precision of the first-stage voice feature extraction, and therefore the third feature extraction precision may be less than the fourth feature extraction precision.

Operation S704: Perform a voice recognition on the second voice data through a preset classification network based on the sample embedded representation feature with the fourth feature extraction precision to obtain a sample recognition result.

The second-stage feature extraction network may perform the second-stage embedded feature extraction on each sample embedded representation feature to obtain the sample embedded representation feature with the fourth feature extraction precision. Subsequently, the voice recognition may then be performed on the second voice data based on the preset classification network and based on the extracted sample embedded representation feature with the fourth feature extraction precision, in other words, a voice classification may be performed on the second voice data, to obtain the sample recognition result.

An example of whether the second voice data includes a foul language word (i.e., a first content type) is used for description. When the voice recognition is performed on the second voice data through the preset classification network based on the sample embedded representation feature with the fourth feature extraction precision, a classification and a recognition may be performed on the second voice data based on a preset foul word library, and it may be determined, based on the extracted sample embedded representation feature with the fourth feature extraction precision, whether a foul language word exists in the second voice data, to obtain a sample recognition result about whether a foul word exists.

Operation S705: Input the sample recognition result and classification label information of the second voice data into a preset loss model, and output a loss result through the preset loss model.

After the plurality of single-word voices (i.e., the second voice data) is obtained through the segmentation based on the MFA, classification label information may be further added to each piece of second voice data. The classification label information may indicate whether a foul language word exists in a single-word voice.

Through the first-stage feature extraction network and the second-stage feature extraction network, the sample embedded representation feature with the fourth feature extraction precision of the second voice data may be extracted, and it may be recognized, based on the sample embedded representation feature with the fourth feature extraction precision, whether the second voice data includes a foul language word. After the sample recognition result is obtained, the sample recognition result and the classification label information of the second voice data may be inputted into the preset loss model, and the loss result may be outputted through the preset loss model.

A label similarity between the sample recognition result and the classification label information may be calculated through the preset loss model.

When the label similarity is greater than a label similarity threshold, it may be determined that the second-stage feature extraction network may accurately extract the sample embedded representation feature of the second voice data, and the preset classification network may perform an accurate voice recognition on the second voice data based on the sample embedded representation feature. In this case, the training of the embedded feature representation system may be stopped, and the embedded feature representation system obtained in this case may be determined as a trained embedded feature representation system.

When the label similarity is less than or equal to the label similarity threshold, it may be determined that the second-stage feature extraction network cannot accurately extract the sample embedded representation feature of the second voice data, or the preset classification network cannot perform an accurate voice recognition on the second voice data based on the sample embedded representation feature. In this case, the embedded feature representation system may continue to be trained, and the training may not be stopped until the label similarity is greater than the label similarity threshold.

Operation S706: Correct a model parameter in the second-stage feature extraction network based on the loss result to obtain a trained embedded feature representation system.

When the label similarity is less than or equal to the label similarity threshold, the model parameter in the second-stage feature extraction network may be corrected based on a correction parameter; and when the label similarity is greater than the label similarity threshold, a training process of the embedded feature representation system may be stopped. During the correction of the model parameter, a correction interval of the model parameter may be preset. The model parameter in the second-stage feature extraction network may include a plurality of sub-model parameters, and each sub-model parameter may correspond to a correction region.

The correction interval of the model parameter may be a value interval of a correction parameter that can be selected to change the model parameter in a current training process. A correction parameter may be selected from the correction interval based on a value of the label similarity. If the label similarity is small (for example, below a correction similarity threshold), a large correction parameter may be selected from the correction interval as the correction parameter in the current training process. If the label similarity is large (for example, above a correction similarity threshold), a small correction parameter may be selected from the correction interval as the correction parameter in the current training process.

A correction similarity threshold may be set. When the label similarity is less than or equal to the correction similarity threshold, the label similarity may be small, and one correction parameter may be randomly selected from a first sub-interval formed by an interval median and an interval maximum of the correction interval as the correction parameter in the current training process. When the label similarity is greater than the correction similarity threshold, the label similarity may be large, and one correction parameter may be randomly selected from a second sub-interval formed by an interval minimum and the interval median of the correction interval as the correction parameter in the current training process, the correction similarity threshold being less than the label similarity threshold. For example, assuming that the correction interval is [a, b], the interval median may be

$$\frac{a + b}{2} ,$$

the first sub-interval may be

$$[ \frac{a + b}{2} , b ] ,$$

and the second sub-interval may be

$$[ a , \frac{a + b}{2} ] .$$

If the label similarity is less than or equal to the correction similarity threshold, one value may be randomly selected from the first sub-interval

$$[ \frac{a + b}{2} , b ]$$

as the correction parameter. If the label similarity is greater than the correction similarity threshold, one value may be randomly selected from the second sub-interval

$$[ a , \frac{a + b}{2} ]$$

as the correction parameter.

After the correction parameter is selected, the corresponding model parameter may be adjusted based on the correction parameter. For example, when the correction parameter is positive, the model parameter may be increased, and when the correction parameter is negative, the model parameter may be decreased.

In the method for training an embedded feature representation system provided, an unsupervised training may be performed on a first-stage feature extraction network through first voice data in an unannotated voice data set; an embedded label feature of second voice data in a single-word voice data set may be extracted through a trained first-stage feature extraction network to obtain sample embedded representation features with a third feature extraction precision, so that these sample embedded representation features with the third feature extraction precision are used as sample data of a second-stage feature extraction network to train the second-stage feature extraction network. In a process of training the second-stage feature extraction network, a supervised learning may be performed, and a model parameter in the second-stage feature extraction network may be learned with reference to classification label information of the second voice data, so that the second-stage feature extraction network can be accurately learned and trained to obtain an embedded feature representation system that can accurately extract a model parameter for correction.

The training processes of the first-stage feature extraction network and the second-stage feature extraction network are described below.

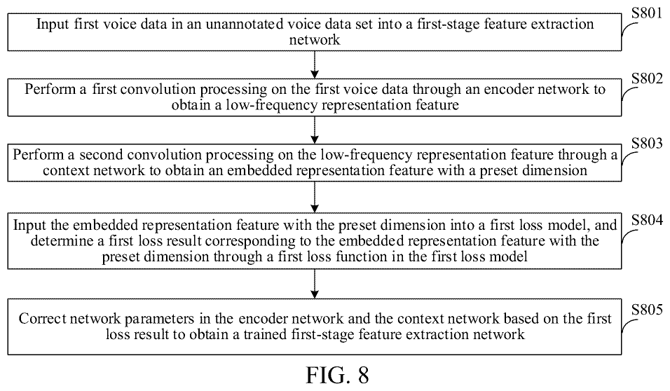

FIG. 8 is a schematic flowchart of one or more aspects of an example of a method for training a first-stage feature extraction network. The first-stage feature extraction network includes an encoder network and a context network. The method for training a first-stage feature extraction network may be implemented by a model training module. The model training module configured to train the first-stage feature extraction network and the model training module configured to train the embedded feature representation system may be the same model training module in the same electronic device, or different model training modules in the same electronic device, or may be different model training modules in different electronic devices. To be specific, the model training module configured to train the first-stage feature extraction network may be a server or a terminal, or may be another device independent of the voice recognition device. As shown in FIG. 8, the following Operation S801 to Operation S805 are cyclically iterated to train the first-stage feature extraction network until the first-stage feature extraction network meets a preset convergence condition and converges.

Operation S801: Input first voice data in an unannotated voice data set into a first-stage feature extraction network.

Operation S802: Perform a first convolution processing on the first voice data through an encoder network to obtain a low-frequency representation feature.

The first-stage feature extraction network may be implemented as a wav2vec model. The wav2vec model may extract an unsupervised voice feature of audio through a multi-layer convolutional neural network. The wav2vec network is a convolutional neural network, and wav2vec uses original audio as an input and calculates a general representation that can be inputted into a voice recognition system. The wav2vec model includes the encoder network (including 5 convolutional processing layers) that encodes original audio x into a latent space z and a context network (including 9 convolutional processing layers) that converts z into a contextualized representation, and a final feature dimension is a 512-dimensional frame. The objective is to use a current frame to predict a future frame on a feature level.

In other words, the encoder network may include a plurality of convolutional processing layers. A convolutional processing may be performed on the first voice data a plurality of times through the plurality of convolutional processing layers to encode the first voice data, thereby obtaining the low-frequency representation feature.

Operation S803: Perform a second convolution processing on the low-frequency representation feature through a context network to obtain an embedded representation feature with a preset dimension.

The context network may include a plurality of convolutional processing layers. A convolutional processing may be performed on the low-frequency representation feature outputted by the encoder network a plurality of times through the plurality of convolutional processing layers to convert the low-frequency representation feature into a contextualized representation, in other words, into an embedded representation feature with the preset dimension.

Operation S804: Input the embedded representation feature with the preset dimension into a first loss model, and determine a first loss result corresponding to the embedded representation feature with the preset dimension through a first loss function in the first loss model.

A contrastive loss function may be selected as a loss function in model training. Through the contrastive loss function, a distance between positive samples is reduced during training, and a distance between negative samples is increased.

Operation S805: Correct network parameters in the encoder network and the context network based on the first loss result to obtain a trained first-stage feature extraction network.

The first voice data may be encoded through the encoder network to obtain the low-frequency representation feature; and the low-frequency representation feature may be converted into the contextualized representation through the context network, in other words, into the embedded representation feature with the preset dimension. A contrastive loss calculation may be performed through the contrastive loss function, so that the distance between positive samples is reduced, and the distance between negative samples is increased. In this way, through a self-supervised learning process, the first-stage feature extraction network can be quickly and accurately trained.

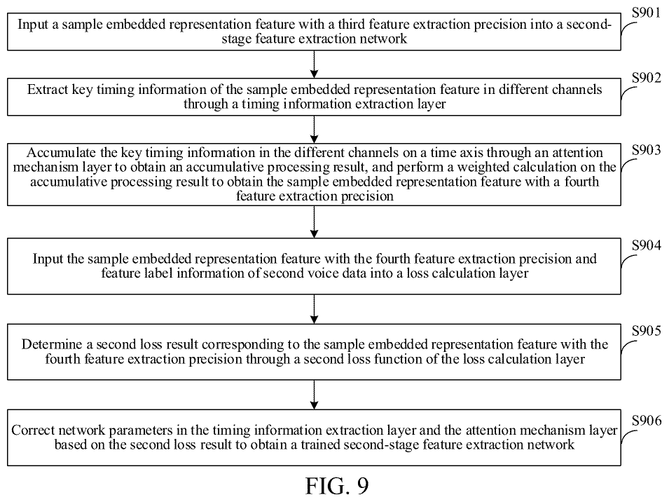

FIG. 9 is a schematic flowchart of one or more aspects of a method for training a second-stage feature extraction network. A second-stage feature extraction network may include a timing information extraction layer, an attention mechanism layer, and a loss calculation layer. The loss calculation layer may include a second loss function. The method for training a second-stage feature extraction network may be implemented by a model training module in a voice recognition device. The method for training a second-stage feature extraction network may be implemented by a model training module. The model training module configured to train the second-stage feature extraction network and the model training module configured to train the first-stage feature extraction network may be the same model training module in the same electronic device, or different model training modules in the same electronic device, or may be different model training modules in different electronic devices. To be specific, the model training module configured to train the second-stage feature extraction network may be a server or a terminal, or may be another device independent of the voice recognition device. As shown in FIG. 9, the following Operation S901 to Operation S906 are cyclically iterated to train the second-stage feature extraction network until the second-stage feature extraction network meets a preset convergence condition and converges.

Operation S901: Input a sample embedded representation feature with a third feature extraction precision into a second-stage feature extraction network.

Operation S902: Extract key timing information of the sample embedded representation feature in different channels through a timing information extraction layer.

The second-stage feature extraction network may be implemented as an ecapa-tdnn model. The timing information extraction layer may be a squeeze-excitation (SE) part in the ecapa-tdnn model. In a calculation process, the SE part may consider an attention mechanism on a time axis, and the SE part may enable the ecapa-tdnn model to learn the key timing information in the inputted sample embedded representation feature.

Operation S903: Accumulate the key timing information in the different channels on a time axis through an attention mechanism layer to obtain an accumulative processing result, and perform a weighted calculation on the accumulative processing result to obtain the sample embedded representation feature with a fourth feature extraction precision.

The attention mechanism layer may be an attentive-stat pool part of the ecapa-tdnn model. The attentive-stat pool part may enable the ecapa-tdnn model to focus on a time dimension based on a self-attention mechanism and accumulate information of the different channels on the time axis. In addition, a weighted averaging form and a weighted variance form may be introduced to make learned embedded representation features more robust and have a differentiation.

Operation S904: Input the sample embedded representation feature with the fourth feature extraction precision and feature label information of second voice data into a loss calculation layer.

The feature label information may indicate whether the voice data is a word in which a user is interested, in other words, whether it is necessary to extract a label corresponding to a word of a feature. For example, for an input voice “I like reading very much”, the word in which the user is interested may be “like” and “reading”. Therefore, “like” and “reading” may be identified in the feature label information to represent that during an embedded feature extraction on the input voice, feature data corresponding to “like” and “reading” needs to be extracted.

Operation S905: Determine a second loss result corresponding to the sample embedded representation feature with the fourth feature extraction precision through a second loss function of the loss calculation layer.

A feature vector corresponding to the feature label information may be acquired based on the feature label information, and a similarity between the sample embedded representation feature and the feature vector may be calculated to obtain the second loss result.

The second loss function may be an Aam-softmax loss function. Through the Aam-softmax loss function, during training, an angle between same-type features can be reduced, and an angle between different-type features can be increased. In this way, the embedded representation feature learned by the second-stage feature extraction network is better. In a process of implementation, a cosine similarity between the sample embedded representation feature and the feature vector may be calculated through the Aam-softmax loss function. The embedded representation feature and the feature vector have features of the same type (same-type features) and have features of different types (different-type features). The angle between same-type features may be a vector angle between two feature vectors corresponding to two same-type features, and the angle between different-type features may be a vector angle between two feature vectors corresponding to two different-type features. The cosine similarity may be calculated through the Aam-softmax loss function, and the second-stage feature extraction network may be trained based on the second loss result corresponding to the cosine similarity, so that when the sample embedded representation feature is extracted by using a trained second-stage feature extraction network, a vector angle between the extracted sample embedded representation feature and a feature vector corresponding to same-type features of the feature vector may be less than an angle threshold, and a vector angle between the extracted sample embedded representation feature and a feature vector corresponding to different-type features may be greater than or equal to the angle threshold. In other words, a similarity between same-type features can be higher, and a similarity between different-type features can be lower.

Operation S906: Correct network parameters in the timing information extraction layer and the attention mechanism layer based on the second loss result to obtain a trained second-stage feature extraction network.

The key timing information of the sample embedded representation feature in the different channels may be extracted through the timing information extraction layer; and the accumulation and the weighted calculation may be sequentially performed on the key timing information in the different channels on the time axis through the attention mechanism layer to obtain the sample embedded representation feature with the fourth feature extraction precision. Through the loss calculation of the second loss function, during training, an angle of the same type is reduced, and an angle of different types is increased. In this way, through a supervised learning process, the second-stage feature extraction network can be quickly and accurately trained.

For the training processes of the embedded feature representation system (including the preset classification network) and the first-stage feature extraction network and the second-stage feature extraction network in the embedded feature representation system, the remaining training processes may be performed in parallel after the first-stage feature extraction network is trained first, or the training processes may be trained sequentially. In other words, the first-stage feature extraction network may be trained first, and then the second-stage feature extraction network and the entire embedded feature representation system may be trained in parallel. Alternatively, the first-stage feature extraction network may be trained first, and then the second-stage feature extraction network and the entire embedded feature representation system may be trained sequentially.

In one non-limiting example, a self-supervised pre-training model may be first trained by using a contrastive learning method based on large-scale unannotated voices, and the model may fully learn embedded representation features of the voices; and then, a Chinese single-word voice may be segmented by using a forced alignment method (Montreal forced aligner, MFA) based on a hidden Markov model, and an embedded representation feature may be further learned through an Aam-softmax loss function. Through the deep learning method, an entire voice recognition model (i.e., the embedded feature representation system) first fully learns an embedded representation feature of a single sentence, and then the embedded representation feature may be further learned based on single-word audio. In this way, during voice keyword matching, the generalization capability and the interference immunity of the voice recognition model can be greatly improved, so that different words can be effectively distinguished, and game voice keyword matching can be performed more precisely.

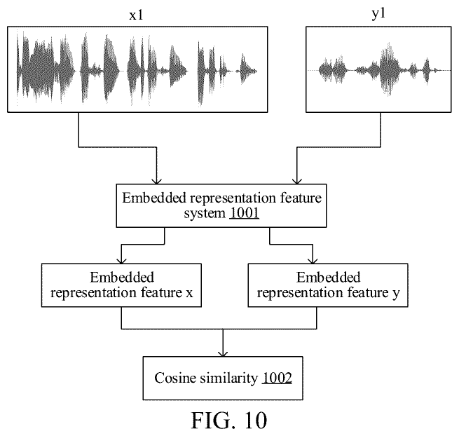

The voice recognition method may be used for secondary check of appropriate audio. FIG. 10 is a schematic diagram of one or more aspects of an example of a voice keyword matching system. For a reported voice x1 that may contain a first content type, such as foul language, an embedded representation feature x of the voice x1 may be extracted in the form a sliding window by using an embedded feature representation system 1001; next, embedded representation features of a foul word library (i.e., a preset contrastive word library) may be traversed to calculate a cosine similarity 1002 between the embedded representation feature x of the reported voice x1 and an embedded representation feature y of foul language y1 in the foul word library. If the cosine similarity is greater than a preset similarity threshold, it may be determined that the reported voice x1 contains the first content type, a foul word.

The embedded feature representation system may include a first-stage feature extraction network and a second-stage feature extraction network. In an example, the first-stage feature extraction network may be a wav2vec model and the second-stage feature extraction network may be an ecapa-tdnn model.

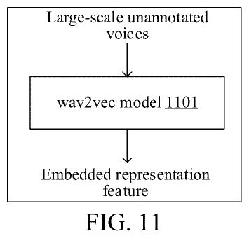

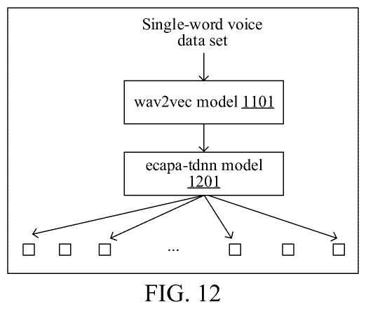

FIG. 11 is a schematic flowchart of one or more aspects of an example of training a wav2vec model. As shown in FIG. 11, a wav2vec model 1101 may be first trained by using a contrastive learning based on large-scale unannotated voices. The operation may be a self-supervised process, and trained wav2vec model may be obtained. FIG. 12 is a schematic flowchart of one or more aspects of an example of training an ecapa-tdnn model. As shown in FIG. 12, after the training of a wav2vec model is completed, the wav2vec model may be fixed based on a single-word voice data set. An embedded expression feature of a single-word voice may be extracted by using the wav2vec model, and then the embedded expression feature may be inputted into an ecapa-tdnn model 1201. The ecapa-tdnn model 1201 may be trained by using an aam-softmax loss function.

Training procedures of the wav2vec model and the ecapa-tdnn model are described below.

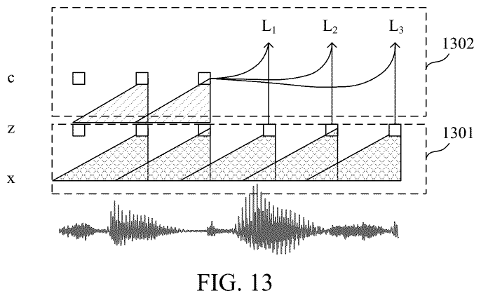

FIG. 13 is a schematic structural diagram of one or more aspects of an example of a wav2vec model. As shown in FIG. 13, the wav2vec model may include an encoder network 1301 and a context network 1302. The encoder network 1301 may include 5 layers of one-dimensional convolution and may have an input being an audio waveform and an output being a low-frequency representation feature. The context network 1302 may include 9 layers of one-dimensional convolution and may have an input being a plurality of low-frequency representation features and an output being a 512-dimensional embedded representation feature. A first loss function that may be used in a training process of the wav2vec model is shown in the following Formula (1):

$${L}_{κ} = - {{\sum }^{T - k}}_{i = 1} ( log σ ( {z}_{i + k}^{T} + {h}_{k} ( {c}_{i} ) ) + {λ E}_{\tilde{z} ∼ pn} [ log σ ( - {z}^{∼ T} {h}_{k} ( {c}_{i} ) ) ] ) \qquad ( 1 )$$

L is the first loss function, k represents a time step, T represents a sequence duration, Z represents an encoder network output, C represents a context network output, h represents an affine transformation, λ represents a quantity of negative samples, pn represents a uniform distribution, and \tilde{z} represents an encoder network output of a negative sample. σ represents a function f(x)=1/(1+exp(−x)), a range is (0, 1), and x is negative infinity to infinity. Here, σ(zᵢ₊ₖ^{T}hₖ(cᵢ) represents a positive sample similarity, and a maximum of the positive sample similarity is 1. Here, σ(−\tilde{z}^{T}hₖ(cᵢ)) is a negative sample similarity, and because a negative sign exists in the function, an overall maximum value is also 1. An overall loss function of Lₖ means that to minimize a distance from a positive sample and increase a distance from a negative sample, an eventually achieved effect may be that each embedded representation feature has a good representability.

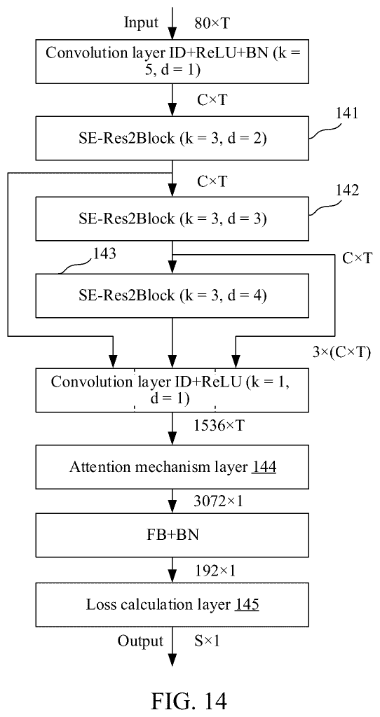

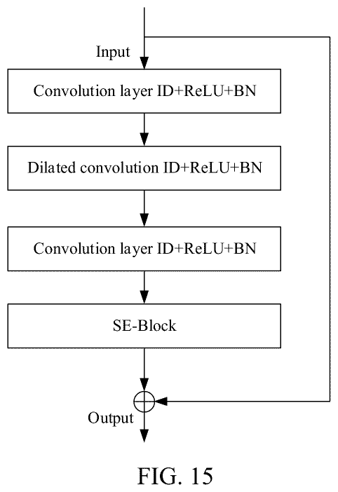

FIG. 14 is a schematic structural diagram of one or more aspects of an example of an ecapa-tdnn model. FIG. 15 is a schematic structural diagram of one or more aspects of an example of an SE-ResBlock part in an ecapa-tdnn model. Referring to both FIG. 14 and FIG. 15, the SE part (i.e., the timing information extraction layer) includes an SE layer 141, an SE layer 142, and an SE layer 143. In a calculation process, the SE part may consider an attention mechanism on a time axis, and the SE part may enable the ecapa-tdnn model to learn key timing information in an inputted feature. The part of an attention mechanism layer 144 may enable the ecapa-tdnn model to focus on a time dimension based on a self-attention mechanism and accumulate information of different channels on the time axis. In addition, a weighted averaging form and a weighted variance form may be introduced to make learned embedded representation features more robust and have a differentiation. The part of a loss calculation layer 145 may perform a loss calculation by using an Aam-softmax loss calculation (corresponding to the second loss function), as shown in the following Formula (2):

$$L = - \frac{1}{N} {\sum }_{i = 1}^{N} log \frac{{e}^{s ( cos ( {θ}_{{y}_{i}} + m ) )}}{{e}^{s ( cos ( {θ}_{{y}_{i}} + m ) )} + {\sum }_{j = 1 , j \neq {y}_{i}}^{n} {e}^{s cos {θ}_{j}}} \qquad ( 2 )$$

L₃ is the second loss function. s and m are both set constants. The second loss function can reduce an angle between same-type features and increase an angle θ (for example, θ_{yi}+m) between different-type features. In this way, learned embedded representation features are better.

The voice recognition method may be applied to the field of game voices and used as a secondary check part of appropriate voices. A cosine similarity between embedded representation features of a to-be-recognized voice and a voice in a foul word library may be calculated to determine whether the to-be-recognized voice contains content of a first type, such as a foul word. In a test process, a foul word can be effectively and precisely located.

One or more aspects of an example of a structure of the voice recognition apparatus 354 being implemented as software modules continues to be described below. Referring back to FIG. 4, the voice recognition apparatus 354 may include:
a frame interception module 3541 that may perform a sliding window interception on a to-be-recognized voice signal to obtain at least two sub-voice signals; a feature extraction module 3542, that may perform a voice feature extraction on each sub-voice signal through a pre-trained embedded feature representation system to obtain a sub-voice embedded representation feature of the corresponding sub-voice signal, the embedded feature representation system including a first-stage feature extraction network and a second-stage feature extraction network, the first-stage feature extraction network that may perform a first-stage voice feature extraction on the sub-voice signal to obtain a first-stage voice feature, the second-stage feature extraction network that may perform a second-stage voice feature extraction on the sub-voice signal based on the first-stage voice feature, a feature extraction precision of the second-stage voice feature extraction being greater than a feature extraction precision of the first-stage voice feature extraction; an acquisition module 3543 that may acquire an embedded representation feature of each contrastive word in a preset contrastive word library; a voice recognition module 3544 that may perform a voice recognition on each sub-voice signal according to the sub-voice embedded representation feature and the embedded representation feature of each contrastive word to obtain a sub-voice recognition result; and a determination module 3545 that may determine a voice recognition result corresponding to the to-be-recognized voice signal according to the sub-voice recognition result of each sub-voice signal.

The frame interception module may further frame the to-be-recognized voice signal by using a sliding window with a preset step to obtain the at least two sub-voice signals, the at least two sub-voice signals having the same frame length.

The apparatus may further include: a window function acquisition module that may acquire a preset window function; and a smoothing module that may smooth each sub-voice signal by using the preset window function to correspondingly obtain at least two smoothed sub-voice signals, wherein the feature extraction module may further perform the voice feature extraction on each smoothed sub-voice signal to obtain the sub-voice embedded representation feature of the corresponding sub-voice signal.

The feature extraction module may further input each sub-voice signal into the first-stage feature extraction network, and may perform a first-stage embedded feature extraction on the sub-voice signal through the first-stage feature extraction network to obtain an embedded representation feature with a first feature extraction precision; and may input the embedded representation feature with the first feature extraction precision into the second-stage feature extraction network, and may perform a second-stage embedded feature extraction on the sub-voice signal through the second-stage feature extraction network to obtain an embedded representation feature with a second feature extraction precision, the first feature extraction precision being less than the second feature extraction precision, the embedded representation feature with the second feature extraction precision forming the sub-voice embedded representation feature of the sub-voice signal.

The voice recognition module may further determine a similarity between the sub-voice embedded representation feature and the embedded representation feature of each contrastive word; and when a similarity between the sub-voice embedded representation feature and the embedded representation feature of any contrastive word is greater than a similarity threshold, may determine that the sub-voice recognition result of the sub-voice signal is a specific recognition result, the specific recognition result being configured for representing that a sub-voice corresponding to the sub-voice signal contains a specific voice word, the specific voice word being a voice word having the same attribute as a contrastive word in the preset contrastive word library.

The determination module may further determine, when a sub-voice recognition result of any sub-voice signal is the specific recognition result, that the voice recognition result corresponding to the to-be-recognized voice signal is the specific recognition result.

The preset contrastive word library may include a contrastive word voice signal of each contrastive word; and the acquisition module may further perform a voice feature extraction on the contrastive word voice signal of each contrastive word through the pre-trained embedded feature representation system to obtain the embedded representation feature of each contrastive word.

The apparatus may further include a model training module that may train the embedded feature representation system, and may input first voice data in an unannotated voice data set into the first-stage feature extraction network, and may train the first-stage feature extraction network in a contrastive learning manner to obtain a trained first-stage feature extraction network; may input second voice data in a single-word voice data set into the trained first-stage feature extraction network, and may perform a first-stage embedded feature extraction on the second voice data through the trained first-stage feature extraction network to obtain a sample embedded representation feature with a third feature extraction precision; may input the sample embedded representation feature with the third feature extraction precision into the second-stage feature extraction network, and may perform a second-stage embedded feature extraction on the second voice data through the second-stage feature extraction network to obtain a sample embedded representation feature with a fourth feature extraction precision, the third feature extraction precision being less than the fourth feature extraction precision; may perform a voice recognition on the second voice data through a preset classification network based on the sample embedded representation feature with the fourth feature extraction precision to obtain a sample recognition result; may input the sample recognition result and classification label information of the second voice data into a preset loss model, and may output a loss result through the preset loss model; and may correct a model parameter in the second-stage feature extraction network based on the loss result to obtain a trained embedded feature representation system.

The first-stage feature extraction network may include an encoder network and a context network; and the model training module may further input the first voice data in the unannotated voice data set into the first-stage feature extraction network; may perform a first convolution processing on the first voice data through the encoder network to obtain a low-frequency representation feature; may perform a second convolution processing on the low-frequency representation feature through the context network to obtain an embedded representation feature with a preset dimension; may input the embedded representation feature with the preset dimension into a first loss model, and may determine a first loss result corresponding to the embedded representation feature with the preset dimension through a first loss function in the first loss model; and may correct network parameters in the encoder network and the context network based on the first loss result to obtain the trained first-stage feature extraction network.

The second-stage feature extraction network may include a timing information extraction layer and an attention mechanism layer; and the model training module may further input the sample embedded representation feature with the third feature extraction precision into the second-stage feature extraction network; may extract key timing information of the sample embedded representation feature in different channels through the timing information extraction layer; may sequentially accumulate the key timing information in the different channels on a time axis through the attention mechanism layer to obtain an accumulative processing result; and may perform a weighted calculation on the accumulative processing result to obtain the sample embedded representation feature with the fourth feature extraction precision.

The second-stage feature extraction network may further include a loss calculation layer, and the loss calculation layer may include a second loss function; and the model training module may further input the sample embedded representation feature with the fourth feature extraction precision and feature label information of the second voice data into the loss calculation layer; may determine a second loss result corresponding to the sample embedded representation feature with the fourth feature extraction precision through the second loss function of the loss calculation layer; and may correct network parameters in the timing information extraction layer and the attention mechanism layer based on the second loss result to obtain a trained second-stage feature extraction network.

The descriptions of the apparatus and its functionality are similar to the description of the method, and have beneficial effects similar to those of the method, and therefore details are not described. For technical details not disclosed in the apparatus description, refer to the description of the method.

One or more aspects described herein may include a computer program product, the computer program product including a computer program or executable instructions, the executable instructions being computer instructions; the computer program or executable instructions being stored in a computer-readable storage medium. A processor of a voice recognition device reads the executable instructions from the computer-readable storage medium, and the processor, when executing the executable instructions, causes the voice recognition device to perform the methods described above.

One or more aspects described herein may include a storage medium having executable instructions stored therein, the executable instructions, when being executed by a processor, causing the processor to perform the methods described above.

The storage medium may be a computer-readable storage medium, for example, a ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disc, a compact disk-read-only memory (CD-ROM), or another memory, or may be various devices including one or any combination of the foregoing memories.

The executable instructions may be written in any form of programming language (including a compiled or interpreted language, or a declarative or procedural language) in the form of a program, software, a software module, a script, or code, and may be deployed in any form, including being deployed as an independent program or being deployed as a module, a component, a subroutine, or another unit suitable for use in a computing environment.

In an example, the executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts). As an example, the executable instructions may be deployed to be executed on one electronic device, or executed on a plurality of electronic devices located at one place, or executed on a plurality of electronic devices that are distributed at a plurality of places and are interconnected by a communication network.

The foregoing descriptions are merely one or more aspects of this application and are not intended to limit the scope of protection of this application. Any modification, equivalent replacement, or improvement made without departing from the spirit and range of this application shall fall within the scope of protection of this application.

What is claimed is:

1. A voice recognition method performed by an electronic device, the voice recognition method comprising:
performing a sliding window interception on a to-be-recognized voice signal to obtain at least a first sub-voice signal and a second sub-voice signal;
performing a first voice feature extraction on the first sub-voice signal using a pre-trained embedded feature representation system to obtain a first sub-voice embedded representation feature of the first sub-voice signal, the pre-trained embedded feature representation system comprising a first-stage feature extraction network and a second-stage feature extraction network, wherein the first-stage feature extraction network performs a first-stage voice feature extraction on the first sub-voice signal to obtain a first-stage voice feature, wherein the second-stage feature extraction network performs a second-stage voice feature extraction on the first sub-voice signal based on the first-stage voice feature, and wherein a first feature extraction precision of the first-stage voice feature extraction is less than a second feature extraction precision of the second-stage voice feature extraction;
performing a second voice feature extraction on the second sub-voice signal using the pre-trained embedded feature representation system to obtain a second sub-voice embedded representation feature of the second sub-voice signal, wherein the first-stage feature extraction network performs the first-stage voice feature extraction on the second sub-voice signal to obtain a second first-stage voice feature, wherein the second-stage feature extraction network performs the second-stage voice feature extraction on the second sub-voice signal based on the second first-stage voice feature;
obtaining an embedded representation feature of each contrastive word in a preset contrastive word library;
performing a first voice recognition on the first sub-voice signal based on the first sub-voice embedded representation feature and the embedded representation feature of each contrastive word to obtain a first sub-voice recognition result;
performing a second voice recognition on the second sub-voice signal based on the second sub-voice embedded representation feature and the embedded representation feature of each contrastive word to obtain a second sub-voice recognition result; and
determining a voice recognition result corresponding to the to-be-recognized voice signal according to the first sub-voice recognition result and the second sub-voice recognition result.

2. The voice recognition method according to claim 1, wherein the sliding window interception comprises:
framing the to-be-recognized voice signal by using a sliding window with a preset step to obtain the first sub-voice signal and the second sub-voice signal, the first sub-voice signal and the second sub-voice signal having a same frame length.

3. The voice recognition method according to claim 1, wherein before the performing a voice feature extraction, the voice recognition method further comprises:
acquiring a preset window function; and
smoothing the first sub-voice signal and the second sub-voice signal using the preset window function to correspondingly obtain a first smoothed sub-voice signal and a second smoothed sub-voice signal,
wherein the performing the voice feature extraction comprises:
performing the voice feature extraction on the first smoothed sub-voice signal to obtain the first sub-voice embedded representation feature; and
performing the voice feature extraction on the second smoothed sub-voice signal to obtain the second sub-voice embedded representation feature.

4. The voice recognition method according to claim 1, wherein:
the performing the first voice feature extraction comprises:
inputting the first sub-voice signal into the first-stage feature extraction network;
performing a first-stage embedded feature extraction on the first sub-voice signal through the first-stage feature extraction network to obtain a first embedded representation feature with a first feature extraction precision;
inputting the first embedded representation feature into the second-stage feature extraction network; and
performing a second-stage embedded feature extraction on the first sub-voice signal through the second-stage feature extraction network to obtain the first embedded representation feature with a second feature extraction precision, the first feature extraction precision being less than the second feature extraction precision, the first embedded representation feature with the second feature extraction precision forming the first sub-voice embedded representation feature of the first sub-voice signal, and
performing the second voice feature extraction comprises:
inputting the second sub-voice signal into the first-stage feature extraction network;
performing the first-stage embedded feature extraction on the second sub-voice signal through the first-stage feature extraction network to obtain a second embedded representation feature with the first feature extraction precision;
inputting the second embedded representation feature into the second-stage feature extraction network; and
performing the second-stage embedded feature extraction on the second sub-voice signal through the second-stage feature extraction network to obtain the second embedded representation feature with the second feature extraction precision, the second embedded representation feature with the second feature extraction precision forming the second sub-voice embedded representation feature of the second sub-voice signal.

5. The voice recognition method according to claim 1, wherein the performing a voice recognition on the first sub-voice signal comprises:
determining a similarity between the first sub-voice embedded representation feature and the embedded representation feature of each contrastive word;
determining, when a similarity between the first sub-voice embedded representation feature and an embedded representation feature of any contrastive word is greater than a similarity threshold, that the first sub-voice recognition result is a specific recognition result indicating that a sub-voice corresponding to the first sub-voice signal comprises a specific voice word with a same attribute as a contrastive word in the preset contrastive word library.

6. The voice recognition method according to claim 5, wherein the determining a voice recognition result comprises:
determining that the voice recognition result corresponding to the to-be-recognized voice signal is the specific recognition result based on the first sub-voice recognition result being the specific recognition result.

7. The voice recognition method according to claim 1, wherein the preset contrastive word library comprises a contrastive word voice signal of each contrastive word, and wherein the obtaining comprises:
performing a voice feature extraction on the contrastive word voice signal of each contrastive word through the pre-trained embedded feature representation system to obtain the embedded representation feature of each contrastive word.

8. The voice recognition method according to claim 1, further comprising training the pre-trained embedded feature representation system by:
inputting first voice data in an unannotated voice data set into the first-stage feature extraction network;
training the first-stage feature extraction network in a contrastive learning manner to obtain a trained first-stage feature extraction network;
inputting second voice data in a single-word voice data set into the trained first-stage feature extraction network;
performing a first-stage embedded feature extraction on the second voice data through the trained first-stage feature extraction network to obtain a sample embedded representation feature with a third feature extraction precision;
inputting the sample embedded representation feature with the third feature extraction precision into the second-stage feature extraction network;
performing a second-stage embedded feature extraction on the second voice data through the second-stage feature extraction network to obtain a sample embedded representation feature with a fourth feature extraction precision, the third feature extraction precision being less than the fourth feature extraction precision;
performing a voice recognition on the second voice data through a preset classification network based on the sample embedded representation feature with the fourth feature extraction precision to obtain a sample recognition result;
inputting the sample recognition result and classification label information of the second voice data into a preset loss model;
outputting a loss result through the preset loss model; and
correcting a model parameter in the second-stage feature extraction network based on the loss result to obtain the pre-trained embedded feature representation system.

9. The voice recognition method according to claim 8, wherein the first-stage feature extraction network comprises an encoder network and a context network, and wherein the training the first-stage feature extraction network in a contrastive learning manner comprises:
performing a first convolution processing on the first voice data through the encoder network to obtain a low-frequency representation feature;
performing a second convolution processing on the low-frequency representation feature through the context network to obtain an embedded representation feature with a preset dimension;
inputting the embedded representation feature with the preset dimension into a first loss model;
determining a first loss result corresponding to the embedded representation feature with the preset dimension through a first loss function in the first loss model; and
correcting network parameters in the encoder network and the context network based on the first loss result to obtain the trained first-stage feature extraction network.

10. The voice recognition method according to claim 8, wherein the second-stage feature extraction network comprises a timing information extraction layer and an attention mechanism layer, and wherein the performing the second-stage embedded feature extraction comprises:
extracting key timing information of the sample embedded representation feature in different channels through the timing information extraction layer;
accumulating the key timing information in the different channels on a time axis through the attention mechanism layer to obtain an accumulative processing result; and
performing a weighted calculation on the accumulative processing result to obtain the sample embedded representation feature with the fourth feature extraction precision.

11. The voice recognition method according to claim 10, wherein the second-stage feature extraction network further comprises a loss calculation layer comprising a second loss function, the voice recognition method further comprising:
inputting the sample embedded representation feature and feature label information of the second voice data into the loss calculation layer;
determining a second loss result corresponding to the sample embedded representation feature with the fourth feature extraction precision through the second loss function of the loss calculation layer; and
correcting network parameters in the timing information extraction layer and the attention mechanism layer based on the second loss result to obtain a trained second-stage feature extraction network.

12. An apparatus comprising:
one or more processors; and
memory storing computer-executable instructions that when executed by the one or more processors, cause the apparatus to perform a voice recognition method comprising:
performing a sliding window interception on a to-be-recognized voice signal to obtain at least a first sub-voice signal and a second sub-voice signal;
performing a first voice feature extraction on the first sub-voice signal using a pre-trained embedded feature representation system to obtain a first sub-voice embedded representation feature of the first sub-voice signal, the pre-trained embedded feature representation system comprising a first-stage feature extraction network and a second-stage feature extraction network, wherein the first-stage feature extraction network performs a first-stage voice feature extraction on the first sub-voice signal to obtain a first-stage voice feature, wherein the second-stage feature extraction network performs a second-stage voice feature extraction on the first sub-voice signal based on the first-stage voice feature, and wherein a first feature extraction precision of the first-stage voice feature extraction is less than a second feature extraction precision of the second-stage voice feature extraction;
performing a second voice feature extraction on the second sub-voice signal using the pre-trained embedded feature representation system to obtain a second sub-voice embedded representation feature of the second sub-voice signal, wherein the first-stage feature extraction network performs the first-stage voice feature extraction on the second sub-voice signal to obtain a second first-stage voice feature, wherein the second-stage feature extraction network performs the second-stage voice feature extraction on the second sub-voice signal based on the second first-stage voice feature;
obtaining an embedded representation feature of each contrastive word in a preset contrastive word library;
performing a first voice recognition on the first sub-voice signal based on the first sub-voice embedded representation feature and the embedded representation feature of each contrastive word to obtain a first sub-voice recognition result;
performing a second voice recognition on the second sub-voice signal based on the second sub-voice embedded representation feature and the embedded representation feature of each contrastive word to obtain a second sub-voice recognition result; and
determining a voice recognition result corresponding to the to-be-recognized voice signal according to the first sub-voice recognition result and the second sub-voice recognition result.

13. The apparatus according to claim 12, wherein the sliding window interception comprises:
framing the to-be-recognized voice signal by using a sliding window with a preset step to obtain the first sub-voice signal and the second sub-voice signal, the first sub-voice signal and the second sub-voice signal having a same frame length.

14. The apparatus according to claim 12, wherein before the performing a voice feature extraction, the voice recognition method further comprises:
acquiring a preset window function; and
smoothing the first sub-voice signal and the second sub-voice signal using the preset window function to correspondingly obtain a first smoothed sub-voice signal and a second smoothed sub-voice signal; and
wherein the performing the voice feature extraction comprises:
performing the voice feature extraction on the first smoothed sub-voice signal to obtain the first sub-voice embedded representation feature; and
performing the voice feature extraction on the second smoothed sub-voice signal to obtain the second sub-voice embedded representation feature.

15. The apparatus according to claim 12, wherein:
the performing the first voice feature extraction comprises:
inputting the first sub-voice signal into the first-stage feature extraction network;
performing a first-stage embedded feature extraction on the first sub-voice signal through the first-stage feature extraction network to obtain a first embedded representation feature with a first feature extraction precision;
inputting the first embedded representation feature into the second-stage feature extraction network; and
performing a second-stage embedded feature extraction on the first sub-voice signal through the second-stage feature extraction network to obtain the first embedded representation feature with a second feature extraction precision, the first feature extraction precision being less than the second feature extraction precision, the first embedded representation feature with the second feature extraction precision forming the first sub-voice embedded representation feature of the first sub-voice signal, and
performing the second voice feature extraction comprises:
inputting the second sub-voice signal into the first-stage feature extraction network;
performing the first-stage embedded feature extraction on the second sub-voice signal through the first-stage feature extraction network to obtain a second embedded representation feature with the first feature extraction precision;
inputting the second embedded representation feature into the second-stage feature extraction network; and
performing the second-stage embedded feature extraction on the second sub-voice signal through the second-stage feature extraction network to obtain the second embedded representation feature with the second feature extraction precision, the second embedded representation feature with the second feature extraction precision forming the second sub-voice embedded representation feature of the second sub-voice signal.

16. The apparatus according to claim 12, wherein the performing a voice recognition on the first sub-voice signal comprises:
determining a similarity between the first sub-voice embedded representation feature and the embedded representation feature of each contrastive word;
determining, when a similarity between the first sub-voice embedded representation feature and an embedded representation feature of any contrastive word is greater than a similarity threshold, that the first sub-voice recognition result is a specific recognition result indicating that a sub-voice corresponding to the first sub-voice signal comprises a specific voice word, the specific voice word being a voice word having a same attribute as a contrastive word in the preset contrastive word library.

17. The apparatus according to claim 16, wherein the determining a voice recognition result comprises:
determining that the voice recognition result corresponding to the to-be-recognized voice signal is the specific recognition result based on the first sub-voice recognition result being the specific recognition result.

18. The apparatus according to claim 12, wherein the preset contrastive word library comprises a contrastive word voice signal of each contrastive word, and wherein the obtaining comprises:
performing a voice feature extraction on the contrastive word voice signal of each contrastive word through the pre-trained embedded feature representation system to obtain the embedded representation feature of each contrastive word.

19. The apparatus according to claim 12, wherein the voice recognition method further comprises training the pre-trained embedded feature representation system by:
inputting first voice data in an unannotated voice data set into the first-stage feature extraction network;
training the first-stage feature extraction network in a contrastive learning manner to obtain a trained first-stage feature extraction network;
inputting second voice data in a single-word voice data set into the trained first-stage feature extraction network;
performing a first-stage embedded feature extraction on the second voice data through the trained first-stage feature extraction network to obtain a sample embedded representation feature with a third feature extraction precision;
inputting the sample embedded representation feature with the third feature extraction precision into the second-stage feature extraction network;
performing a second-stage embedded feature extraction on the second voice data through the second-stage feature extraction network to obtain a sample embedded representation feature with a fourth feature extraction precision, the third feature extraction precision being less than the fourth feature extraction precision;
performing a voice recognition on the second voice data through a preset classification network based on the sample embedded representation feature with the fourth feature extraction precision to obtain a sample recognition result;
inputting the sample recognition result and classification label information of the second voice data into a preset loss model;
outputting a loss result through the preset loss model; and
correcting a model parameter in the second-stage feature extraction network based on the loss result to obtain the pre-trained embedded feature representation system.

20. A non-transitory computer readable medium storing instructions that when executed by one or more processors, cause the one or more processors to perform a voice recognition method comprising:
performing a sliding window interception on a to-be-recognized voice signal to obtain at least a first sub-voice signal and a second sub-voice signal;
performing a first voice feature extraction on the first sub-voice signal using a pre-trained embedded feature representation system to obtain a first sub-voice embedded representation feature of the first sub-voice signal, the pre-trained embedded feature representation system comprising a first-stage feature extraction network and a second-stage feature extraction network, wherein the first-stage feature extraction network performs a first-stage voice feature extraction on the first sub-voice signal to obtain a first-stage voice feature, wherein the second-stage feature extraction network performs a second-stage voice feature extraction on the first sub-voice signal based on the first-stage voice feature, and wherein a first feature extraction precision of the first-stage voice feature extraction is less than a second feature extraction precision of the second-stage voice feature extraction;
performing a second voice feature extraction on the second sub-voice signal using the pre-trained embedded feature representation system to obtain a second sub-voice embedded representation feature of the second sub-voice signal, wherein the first-stage feature extraction network performs the first-stage voice feature extraction on the second sub-voice signal to obtain a second first-stage voice feature, wherein the second-stage feature extraction network performs the second-stage voice feature extraction on the second sub-voice signal based on the second first-stage voice feature;
obtaining an embedded representation feature of each contrastive word in a preset contrastive word library;
performing a first voice recognition on the first sub-voice signal based on the first sub-voice embedded representation feature and the embedded representation feature of each contrastive word to obtain a first sub-voice recognition result;
performing a second voice recognition on the second sub-voice signal based on the second sub-voice embedded representation feature and the embedded representation feature of each contrastive word to obtain a second sub-voice recognition result; and
determining a voice recognition result corresponding to the to-be-recognized voice signal according to the first sub-voice recognition result and the second sub-voice recognition result.
